(19) United States
(12) Patent Application Publication
(10) Pub. No.: US 2023/0352917 A1
(43) Pub. Date: Nov. 2, 2023

(54) APPARATUS AND METHOD FOR INSTALLING SPACERS ON SPANS OF WIRE

(71) Applicant: FT HOLDINGS INC., Calgary (CA)

(72) Inventor: Daniel John CLARKE, Calgary (CA)

(73) Assignee: FT HOLDINGS INC., Calgary, AB (CA)

(21) Appl. No.: 18/103,251

(22) Filed: Jan. 30, 2023

(30) Foreign Application Priority Data
May 2, 2022 (CA) 3157157

(51) Int. Cl. H02G 1/02; B25J 5/02; H02G 7/12

(52) U.S. Cl. CPC H02G 1/02; B25J 5/02; H02G 7/12; B25J 15/0019

(57) ABSTRACT

A system and method are provided for the installation of dual line spacers, triple line spacers or quad line spacers on transmission power lines. A robotic assembly is configured to traverse along 2, 3 or 4 wires using motorized wheel mechanisms, where the robotic assembly can hold a number of 2, 3 or 4-wire spacers and dispense them onto the wires for installation. The robotic assembly uses impact wrenches that can position onto the fastening bolts of the line spacers and tighten the bolts to hold the line spacers on the wires. Once a line spacer is installed, the robotic assembly releases the installed line spacer and then traverses along the wires to the next position for a next line spacer to be installed.

### CROSS-REFERENCE TO RELATED APPLICATIONS

This application claims priority of Canadian patent application serial no. 3,157,157 filed May 2, 2023, which is incorporated by reference into this application in its entirety.

### TECHNICAL FIELD

The present disclosure is related to the field of installing spacers on spans of wire strung between supporting structures such as poles or towers, in particular, spans of electric power transmission lines.

### BACKGROUND

On electrical power lines having spans of multiple conductors strung between supporting structures, such as poles, towers and the like, for the transmission of electrical current, spacers can be used at predetermined intervals along the spans to separate the multiple conductors and to maintain a predetermined distance between each of the multiple conductors.

FIG. 1 shows an underside perspective view, and FIG. 2 shows one embodiment of an overhead perspective view of prior art dual line spacer 1, as manufactured by Preformed Line Products Company of Cleveland, Ohio under the trade name CUSHION-GRIP® Twin Spacer. A similarly configured device is manufactured by America Fujikura Ltd. of Duncan, South Carolina under the trade name Speed-Grip® Spacers. Other similar products by other manufacturers may exist. The purpose of dual line spacer 1 is to be clamped onto dual conductors that are frequently are used on transmission power lines to prevent the conductors from contacting each other as well as protecting the conductors against bending stresses caused by sub-conductor oscillation and aeolian vibration by dampening such vibrations in the conductors. In normal use, a plurality of dual line spacers 1 is fitted to each conductor group of the power line, substantially equally spaced at a predetermined interval along each span. Currently, dual line spacers are generally fitted to transmission power lines by trained personnel traversing the spans on wheeled carts that are fitted to the wires that allow the personnel to travel down the wire and fit the dual line spacers manually.

Each dual line spacer 1 comprises of lower body 2, upper body 3, and clamping bolt 4 that is retained prior to installation by being partially threaded into female threaded hole 14 in upper body 3. Lower body 2 and upper body 3 are each fitted with a plurality of hooks 7 which interface with the opposing body to connect lower body 2 to upper body 3 while still allowing relative motion of lower body 2 with respect to upper body 3 along the direction depicted by arrow 12. Lower body 2 and upper body 3 are each fitted with a plurality of wire retaining blocks 5 which are constructed of a pliable material such as rubber to allow substantial deformation to occur during the installation process. Each wire retaining blocks 5 is fitted with a concave surface 11. It can be seen that by moving lower body 2 with respect to upper body 3 in the direction indicated by arrow 12 such that the plurality of wire retaining blocks 5 fitted to lower body 2 are moved towards the plurality of wire retaining blocks 5 fitted to upper body 3 until contact is made, two closed cylindrical cavities are formed between concave surfaces 11 fitted to wire retaining blocks 5.

FIG. 3 shows a depiction of dual line spacer 1 prior to installation onto the two wires 10 that make up each dual conductor group. In this configuration, lower body 2 is positioned relative to upper body 3 such that a substantial gap exists between wire retaining blocks 5. This gap is large enough to allow wires 10 to be manually inserted into the space that exists between concave surfaces 11 of wire retaining blocks 5. Once both wires are thus inserted, upper body 3 can be moved in the direction indicated by arrow 13 as depicted in the sectioned view of dual line spacer 1 shown in FIG. 4 until the wire retaining blocks 5 fitted to upper body 3 are bought into contact with wire retaining blocks 5 fitted to lower body 2 and wires 10 are trapped between the concave surfaces 11 of wire retaining blocks 5. Once this has occurred, clamping bolt 4 is manually threaded into threaded hole 14 in upper body 3 until convex conical end 15 of clamping bolt 4 contacts the interior of concave conical upper surface 8 of the retaining hole 6 that passes through lower body 2. Once this stage is reached, it can be seen that by further tightening clamping bolt 4 with a suitable tool, convex conical end 15 of clamping bolt 4 applies substantial force to the interior of concave conical upper surface 8 of the retaining hole 6, forcing clamping bolt 4 and upper body 3 to move in the direction of arrow 13. This motion compresses wire retaining blocks 5 as they contact each other with great force, as well as compressing the concave surfaces 11 of wire retaining blocks 5 around the outer diameter of wires 10.

FIG. 5 shows a sectioned view of dual line spacer 1 after clamping bolt 4 has been fully threaded into female threaded hole 14 in upper body 3. In this configuration, convex conical end 15 of clamping bolt 4 no longer contacts the interior of concave conical upper surface 8 of the retaining hole 6 that passes through lower body 2. In this configuration, the lower unthreaded cylindrical surface 16 of clamping bolt 4 is now inserted into the cylindrical inner surface of retaining hole 6, which has caused the axis of clamping bolt 4 to be substantially coaxial with the axis of clamping bolt 4 cylindrical inner surface of retaining hole 6. upper body 3 has moved as far as possible in the direction of arrow 13, fully compressing wire retaining blocks 5 into each other as well as firmly compressing the concave surfaces 11 of wire retaining blocks 5 around the outer diameter of wires 10. This firmly secures dual line spacer 1 to wires 10, preventing further relative movement between dual line spacer 1 and wires 10. Once this configuration is reached, upper bolt head 17 is further tightened until the torque being transmitted into clamping bolt 4 by the tool being used to tighten clamping bolt 4 is sufficient to cause the necked down section 18 of clamping bolt 4 to fail and break away from the main body of clamping bolt 4. The necked down section 18 of clamping bolt 4 is carefully sized to ensure that mechanical failure of necked down section 18 occurs when the clamping bolt 4 has reached the required torque specification.

This process is repeated until a plurality of dual line spacers 1 are fitted to each conductor group of the power line, substantially equally spaced at a predetermined interval along each span, as depicted in FIG. 7.

FIG. 8 and FIG. 9 show a perspective view of an open and closed prior art quad line spacer 160, as manufactured by Preformed Line Products Company of Cleveland, Ohio under the trade name CUSHION-GRIP® Spacer Damper. Other similar products by other manufacturers may exist. The purpose of the quad line spacer 160 is to be clamped onto quad conductors that are frequently are used on transmission power lines to prevent the conductors from contacting each other as well as protecting the conductors against bending stresses caused by sub-conductor oscillation and aeolian vibration. In normal use, a plurality of quad line spacers 160 is fitted to each conductor group of the power line, substantially equally spaced at a predetermined interval along each span. Currently, quad line spacers 160 are generally fitted to power transmission lines through the use of humans traversing the spans on wheeled carts that are fitted to the wires that allow the person to travel down the wire and fit the dual line spacers manually. This method is time consuming, relatively dangerous and expensive. Thus, a need for a robotic method of installing these devices exists to make the process faster, safer, and cheaper.

Quad line spacer 160 comprises of main body 162 to which is attached four clamping arms 167. A hinged clamp mechanism 163 is pinned to each clamping arm 167 in such a way as to allow the hinged clamp mechanism 163 to pivot freely about clamping arm 167 in a direction indicated by arrow 166. Each hinged clamp mechanism 163 is fitted with a clamping bolt 161 which is inserted into slotted hole 215 of hinged clamp mechanism 163 prior to installation as shown in FIG. 10 which is a detail view of FIG. 8. clamping bolt 161 is held captive in slotted hole 215 by retaining washer 216 which in some embodiments is made of a pliable material such as rubber. Retaining washer 216 fits tightly over the threads of clamping bolt 161, preventing clamping bolt 161 from falling out of slotted hole 215 prior to installation. Each of the hinge clamp mechanisms 163 and clamping arms 167 have a plurality of wire retaining blocks 164 which are constructed of a pliable material such as rubber to allow substantial deformation to occur during the installation process. Each wire retaining blocks 164 is fitted with a concave surface 170. It can be seen that pivoting the hinged clamp mechanism 163 about the rotation direction indicated by arrow 166 brings the wire retaining block 164 of the hinge clamp mechanism 163 in contact with the wire retaining block 164 of the clamping arm 167 creating a closed cylindrical surface. The main body 162 of quad line spacer 160 is perforated by a relatively large square hole 221 as can be seen in FIG. 8 and FIG. 9.

FIG. 8 shows a depiction of quad line spacer 160 prior to installation onto the four wires 165 that make up the quad conductor group. In this configuration the four Hinged Clamp Mechanisms are open to allow the four wires 165 to pass through and lightly contact the concave surface 170 of the wire retaining blocks 164. The Hinged Clamp Mechanism is then closed by pivoting about the rotation direction indicated by Arrow [166] to captivate the wires 165 within the concave surfaces 170 of the wire retaining blocks 164. Clamping bolts 161 are then threaded into threaded holes 217. Upon tightening the clamping bolts 161 with a suitable tool, the wire retaining blocks 164 compress and deform to firmly grasp the wire. The clamping bolts 161 are torqued until the specially designed clamping bolt 161 head shears off at the designed installation torque. See FIG. 5 and FIG. 6 and description therein for more information relating to clamping bolt 161 design. FIG. 9 shows quad line spacer 160 configured after installation on the four wires 165 (not shown).

This process is repeated until a plurality of quad line spacers 160 are fitted to each conductor group of the powerline, substantially equally spaced at a predetermined interval along each span, as depicted in FIG. 11.

FIG. 12 and FIG. 13 show a perspective view of an open and closed triple line spacer 219, as manufactured by Preformed Line Products Company of Cleveland, Ohio under the trade name CUSHION-GRIP® Spacer Damper. Other similar products by other manufacturers may exist, such as manufactured by UAB AIZ of Vilnius, Lithuania among others. The purpose of the triple line spacer 219 is to be clamped onto triple conductors that are frequently are used on transmission power lines to prevent the conductors from contacting each other as well as protecting the conductors against bending stresses caused by sub-conductor oscillation and aeolian vibration. In normal use, a plurality of triple line spacers 219 is fitted to each conductor group of the power line, substantially equally spaced at a predetermined interval along each span. Currently, triple line spacers 219 are generally fitted to power transmission lines through the use of humans traversing the spans on wheeled carts that are fitted to the wires that allow the person to travel down the wire and fit the dual line spacers manually. This method is time consuming, relatively dangerous, and expensive. Thus, a need for a robotic method of installing these devices exists to make the process faster, safer and cheaper.

Triple line spacer 219 is very similar in construction to quad line spacer 160 and consists of a main body 218 to which is attached three clamping arms 167. A hinged clamp mechanism 163 is pinned to each clamping arm 167 in such a way as to allow the hinged clamp mechanism 163 to pivot freely about clamping arm 167 in a direction indicated by arrow 166. Each hinged clamp mechanism 163 is fitted with a clamping bolt 161 which is inserted into slotted hole 215 of hinged clamp mechanism 163 prior to installation as shown in FIG. 14 which is a detail view of FIG. 12. clamping bolt 161 is held captive in slotted hole 215 by retaining washer 216 which in some embodiments is made of a pliable material such as rubber. retaining washer 216 fits tightly over the threads of clamping bolt 161, preventing clamping bolt 161 from falling out of slotted hole 215 prior to installation. Each of the hinge clamp mechanisms 163 and clamping arms 167 have a plurality of wire retaining blocks 164 which are constructed of a pliable material such as rubber to allow substantial deformation to occur during the installation process. Each wire retaining blocks 164 is fitted with a concave surface 170. It can be seen that pivoting the hinged clamp mechanism about the rotation direction indicated by arrow 166 brings the wire retaining block 164 of the hinge clamp mechanism 163 in contact with the wire retaining block 164 of the clamping arm 167 creating a closed cylindrical surface. The main body 218 of triple line spacer 219 is perforated by a relatively large triangular hole 222 as can be seen in FIG. 12 and FIG. 13.

FIG. 12 shows a depiction of triple line spacer 219 prior to installation onto the three wires 165 that make up the triple conductor group. In this configuration, each of the plurality of hinged clamp mechanisms is open to allow the three wires 165 to pass through and lightly contact the concave surface 170 of the wire retaining blocks 164. The hinged clamp mechanism is then closed by pivoting about the rotation direction indicated by arrow 166 to captivate the wires 165 within the concave surfaces 170 of the wire retaining blocks 164. clamping bolts 161 are then threaded into threaded holes 217. Upon tightening the clamping bolts 161 with a suitable tool, the wire retaining blocks 164 compress and deform to firmly grasp the wire. The clamping bolts 161 are torqued until the specially designed clamping bolt 161 head shears off at the designed installation torque. See FIG. 5 and FIG. 6 and description therein for more information relating to clamping bolt 161 design. FIG. 13 shows triple line spacer 219 configured after installation on the four wires 165 (not shown).

This process is repeated until a plurality of triple line spacers 219 are fitted to each conductor group of the powerline, substantially equally spaced at a predetermined interval along each span, as depicted in FIG. 15.

As the manual process of manually mounting line spacers on transmission power lines is time consuming, relatively dangerous, and expensive, a need for an automated method of installing these devices exists to make the process faster, safer and cheaper.

### SUMMARY

An apparatus and method are provided for installing spacers on spans of wire strung between supporting structures such as poles or towers, such as on electric power transmission lines wherein each phase of conductor on the electric power transmission line can be provided as a bundle of two or more electrical conductor wires.

Broadly stated, in some embodiments, an apparatus can be provided for installing spacers on at least two wires configured as a span of the wires, each of the spacers comprising at least one clamping bolt for clamping the spacers to the span of the wires, the apparatus comprising: a rolling chassis configured to move along the span of the wires; a magazine assembly operatively disposed on the rolling chassis, the magazine assembly configured to hold at least one of the spacers, the magazine assembly further configured to position one of the spacers on the span of the wires; and a bolt tightening assembly disposed on the rolling chassis, the bolt tightening assembly configured to fasten the spacers onto the span of the wires.

Broadly stated, in some embodiments, the rolling chassis can comprise a plurality of wheel truck assemblies that are configured to contact the span of wires and to move the rolling chassis along the span of the wires.

Broadly stated, in some embodiments, the plurality of wheel truck assemblies can comprise one or more wheels further comprising an electric motor disposed therein powered by a battery disposed on the apparatus.

Broadly stated, in some embodiments, the rolling chassis can comprise at least two front wheels configured to stabilize the rolling chassis on the span of the wires.

Broadly stated, in some embodiments, the apparatus can further comprise a computer, a radio modem operatively coupled to the computer, and at least one antenna operatively coupled to the radio modem disposed thereon, the radio modem configured to receive wireless commands from a ground station via the at least one antenna and to relay the wireless commands to the computer, wherein the computer is configured to control operation of one or more of the rolling chassis, the magazine assembly and the bolt tightening assembly in response to the wireless commands.

Broadly stated, in some embodiments, the bolt tightening assembly can comprise: a support arm operatively coupled to the rolling chassis; an impact wrench comprising a socket configured for tightening the at least one clamping bolt; and a positioning mechanism operatively coupling the impact wrench to the support arm, the positioning mechanism configured to lower and raise the impact wrench to and from the spacers thereby enabling the socket to engage the at least one clamping bolt.

Broadly stated, in some embodiments, the positioning mechanism can further comprise a side movement mechanism operatively coupling the impact wrench to the positioning mechanism thereby enabling side to side movement of the impact wrench within the positioning mechanism as the impact wrench and the socket tightens the at least one clamping bolt.

Broadly stated, in some embodiments, the side movement mechanism can comprise slide rods slidably coupled to slide tubes.

Broadly stated, in some embodiments, the apparatus can be configured for installing a plurality of the spacers on at least three wires configured as the span of the wires.

Broadly stated, in some embodiments, the magazine assembly can further comprise a retention pin assembly configured to engage and retain at least one of the spacers whereby the at least one of the spacers moves along the span of the wires as the rolling chassis moves along the span of the wires.

Broadly stated, in some embodiments, a method can be provided for installing spacers on at least two wires configured as a span of the wires, each of the spacers comprising at least one clamping bolt for clamping the spacers to the span of the wires, the method comprising: placing an apparatus on the span of the wires, the apparatus comprising: a rolling chassis configured to move along the span of the wires, a magazine assembly operatively disposed on the rolling chassis, the magazine assembly configured to hold at least one of the spacers, the magazine assembly loaded with at least one of the spacers, the magazine assembly further configured to position one of the spacers on the span of the wires, and a bolt tightening assembly disposed on the rolling chassis, the bolt tightening assembly configured to fasten the spacers onto the span of the wires; moving the apparatus along the span of the wires to a position where one of the spacers is to be installed thereon; and clamping the spacer to the span of the wires with the bolt tightening assembly.

Broadly stated, in some embodiments, the method can comprise moving the rolling chassis along the span of the wires using the plurality of wheel truck assemblies.

### BRIEF DESCRIPTION OF THE DRAWINGS

FIG. 1 is a bottom perspective view depicting one embodiment of a prior art dual line spacer shown in an “open” configuration.

FIG. 2 is a top perspective view depicting the prior art dual line spacer of FIG. 1.

FIG. 3 is a side elevation view depicting the prior art dual line spacer of FIG. 1.

FIG. 4 is a side elevation cross-section view depicting the prior art dual line spacer of FIG. 3 shown in the process of being attached to a pair of wires.

FIG. 5 is a side elevation cross-section view depicting the prior art dual line spacer of FIG. 4 after being clamped to the pair of wires.

FIG. 6 is a side elevation view depicting the prior art dual line spacer of FIG. 5.

FIG. 7 is a perspective view depicting a plurality of the prior art dual line spacers of FIG. 1 installed on a pair of wires.

FIG. 8 is a perspective view depicting one embodiment of a prior art quad line spacer with its clamp mechanisms in an open position.

FIG. 9 is a perspective view depicting one embodiment of the prior art quad line spacer of FIG. 8 with its clamp mechanisms in a closed position.

FIG. 10 is a perspective close-up view depicting a clamp mechanism of the prior art quad line spacer of FIG. 8.

FIG. 11 is a perspective view depicting a plurality of the prior art quad line spacers of FIG. 9 installed on a set of four wires.

FIG. 12 is a perspective view depicting one embodiment of a prior art triple line spacer with its clamp mechanisms in an open position.

FIG. 13 is a perspective view depicting one embodiment of the prior art triple quad line spacer of FIG. 12 with its clamp mechanisms in a closed position.

FIG. 14 is a perspective close-up view depicting a clamp mechanism of the prior art triple line spacers of FIG. 12.

FIG. 15 is a perspective view depicting a plurality of the prior art triple line spacers of FIG. 12 installed on a set of three wires.

FIG. 16 is a top perspective view depicting one embodiment of a dual line spacer installation robot.

FIG. 17 is a bottom perspective view depicting the dual line spacer installation robot of FIG. 16.

FIG. 18 is a top perspective view depicting the dual line spacer installation robot of FIG. 16 loaded with a plurality of the prior art dual line spacers of FIG. 1.

FIG. 19 is a bottom perspective view depicting the dual line spacer installation robot of FIG. 18.

FIG. 20 is a rear elevation view depicting the rolling assembly of the dual line spacer installation robot of FIG. 16 with the wheel truck assemblies in the open position.

FIG. 21 is a top plan view depicting the dual line spacer installation robot of FIG. 20.

FIG. 22 is a rear elevation view depicting the rolling assembly of the dual line spacer installation robot of FIG. 20 with the wheel truck assemblies in the closed position.

FIG. 23 is a front elevation view depicting the dual line spacer installation robot of FIG. 22.

FIG. 24 is a top perspective view depicting the left hand wheel truck assembly of the dual line spacer installation robot of FIG. 20.

FIG. 25 is a top plan view depicting the left hand wheel truck assembly of FIG. 24.

FIG. 26 is a top perspective view depicting the right hand wheel truck assembly of the dual line spacer installation robot of FIG. 20.

FIG. 27 is a top plan view depicting the right hand wheel truck assembly of FIG. 26.

FIG. 28 is a top perspective view depicting the magazine assembly of the dual line spacer installation robot of FIG. 16.

FIG. 29 is a bottom perspective view depicting the magazine assembly of FIG. 28.

FIG. 30 is a top perspective view depicting the right hand magazine rod of the magazine assembly of FIG. 28.

FIG. 31 is a bottom perspective view depicting the right hand magazine rod of FIG. 30.

FIG. 32 is a side elevation cross-section view depicting a detent block extended away from the magazine rod of FIG. 30.

FIG. 33 is a cross-section view depicting the detent block of FIG. 32 along section lines E-E.

FIG. 34 is a side elevation cross-section view depicting the detent block of FIG. 32 compressed against the magazine rod.

FIG. 35 is a cross-section view depicting the detent block of FIG. 34 along section lines E-E.

FIG. 36 is a top exploded perspective view depicting the magazine assembly of FIG. 28.

FIG. 37 is a front elevation view depicting the magazine assembly of FIG. 36 with the magazine rods extending outwards from each other.

FIG. 38 is a front elevation view depicting the magazine assembly of FIG. 36 with the magazine rods extending inwards to each other.

FIG. 39 is a side elevation view depicting a first step of the prior art dual line spacer of FIG. 1 being loaded onto the magazine assembly of FIG. 28.

FIG. 40 is a cross-section top plan view depicting the prior art dual line spacer of FIG. 39 along section lines A-A.

FIG. 41 is a side elevation view depicting detail B of FIG. 39.

FIG. 42 is a side elevation view depicting detail C of FIG. 39.

FIG. 43 is a top plan view depicting detail A of FIG. 40.

FIG. 44 is a top plan view depicting detail B of FIG. 40.

FIG. 45 is a side elevation view depicting a second step of the prior art dual line spacer of FIG. 1 being loaded onto the magazine assembly of FIG. 28.

FIG. 46 is a cross-section top plan view depicting the prior art dual line spacer of FIG. 45 along section lines G-G.

FIG. 47 is a side elevation view depicting detail A of FIG. 45.

FIG. 48 is a side elevation view depicting detail B of FIG. 45.

FIG. 49 is a top plan view depicting detail A of FIG. 46.

FIG. 50 is a top plan view depicting detail B of FIG. 46.

FIG. 51 is a top perspective view depicting the magazine assembly of FIG. 28 loaded with a plurality of the prior art dual line spacer of FIG. 1.

FIG. 52 is a bottom perspective view depicting the loaded magazine assembly of FIG. 51.

FIG. 53 is a side elevation view depicting the loaded magazine assembly of FIG. 51.

FIG. 54 is a cross-section end elevation view depicting the loaded magazine assembly of FIG. 51 along section lines A-A, during a first step of installing a prior art dual line spacer of FIG. 1 on a pair of wires.

FIG. 55 is a cross-section end elevation view depicting the loaded magazine assembly of FIG. 54 during a second step of installing a prior art dual line spacer of FIG. 1 on a pair of wires.

FIG. 56 is a cross-section end elevation view depicting the loaded magazine assembly of FIG. 54 during a third step of installing a prior art dual line spacer of FIG. 1 on a pair of wires.

FIG. 57 is a cross-section end elevation view depicting the loaded magazine assembly of FIG. 54 during a fourth step of installing a prior art dual line spacer of FIG. 1 on a pair of wires.

FIG. 58 is a cross-section top plan view of one of a plurality of the prior art dual line spacer of FIG. 1 installed on a pair of wires.

FIG. 59 is a top plan view depicting detail A of FIG. 58.

FIG. 60 is a top plan view depicting detail B of FIG. 58.

FIG. 61 is a cross-section end elevation view depicting the loaded magazine assembly of FIG. 54 during a fifth step of installing a prior art dual line spacer of FIG. 1 on a pair of wires.

FIG. 62 is a top plan view depicting the loaded magazine assembly of FIG. 53 after installing one of the plurality of the prior art dual line spacer of FIG. 1 on a pair of wires.

FIG. 63 is a cross-section top plan view depicting detail A of FIG. 62.

FIG. 64 is a cross-section top plan view depicting detail B of FIG. 62.

FIG. 65 is a top perspective view depicting one embodiment of a bolt tightening assembly of the dual line spacer installation robot of FIG. 16.

FIG. 66 is a bottom perspective view depicting the bolt tightening assembly of FIG. 65.

FIG. 67 is a cross-section end elevation view depicting the bolt tightening assembly of FIG. 65 along section lines A-A.

FIG. 68 is an end elevation view depicting detail A of FIG. 67.

FIG. 69 is a front elevation view depicting a prior art quad line spacer loosely installed on a set of four wires.

FIG. 70 is a top perspective view depicting one embodiment of a quad line spacer installation robot.

FIG. 71 is a bottom perspective view depicting the quad line spacer installation robot of FIG. 70.

FIG. 72 is a front elevation view depicting the quad line spacer installation robot prior to installation on a set of four wires.

FIG. 73 is a front elevation view depicting the quad line spacer installation robot of FIG. 72 with left and right bogey support arms rotated for positioning on a set of four wires.

FIG. 74 is a top plan view depicting the quad line spacer installation robot of FIG. 70 prior to cocking the pusher assembly thereof.

FIG. 75 is a cross-section side elevation view depicting the quad line spacer installation robot of FIG. 74 along section lines A-A.

FIG. 76 is a top plan view depicting the quad line spacer installation robot of FIG. 74 after the pusher assembly has been cocked.

FIG. 77 is a cross-section side elevation view depicting the quad line spacer installation robot of FIG. 76 along section lines A-A.

FIG. 78 is a top plan view depicting detail B of FIG. 76.

FIG. 79 is a top perspective view depicting the quad line spacer installation robot of FIG. 70 mounted on a set of four wires prior to installing a plurality of the prior art quad line spacers of FIG. 69.

FIG. 80 is a top perspective view depicting the quad line spacer installation robot of FIG. 79 moving towards the plurality of the prior art quad line spacers.

FIG. 81 is a top perspective view depicting the quad line spacer installation robot of FIG. 80 fully loaded with the prior art quad line spacers.

FIG. 82 is a top perspective view depicting the quad line spacer installation robot of FIG. 81 after having installed the plurality of the prior art quad line spacers.

FIG. 83 is a side elevation view depicting the quad line spacer installation robot of FIG. 70.

FIG. 84 is a front elevation view depicting the quad line spacer installation robot of FIG. 83 along section lines A-A.

FIG. 85 is a front elevation view depicting the quad line spacer installation robot of FIG. 84 with the left and right bogey support arms in an extended configuration.

FIG. 86 is a front elevation view depicting the quad line spacer installation robot of FIG. 84 with the left and right bogey support arms in a retracted configuration.

FIG. 87 is a side elevation view depicting one of the idler wheel bogey assemblies of the quad line spacer installation robot of FIG. 70.

FIG. 88 is a side elevation view depicting the idler wheel bogey assembly of FIG. 87 in a wire locking configuration.

FIG. 89 is a front elevation view depicting the idler wheel bogey assembly of FIG. 88.

FIG. 90 is a rear elevation view depicting the quad line spacer installation robot of FIG. 70 prior to fastening the upper bolts of a quad line spacer.

FIG. 91 is a rear elevation view depicting the quad line spacer installation robot of FIG. 90 fastening the upper bolts of the quad line spacer.

FIG. 92 is a rear elevation view depicting the quad line spacer installation robot of FIG. 91 prior to fastening the lower bolts of the quad line spacer.

FIG. 93 is a rear elevation view depicting the quad line spacer installation robot of FIG. 92 fastening the lower bolts of the quad line spacer.

FIG. 94 is a rear elevation view depicting the quad line spacer installation robot of FIG. 93 after installing the quad line spacer.

FIG. 95 is a rear elevation view depicting detail A of FIG. 94 showing the spacer retention pins in a retracted position.

FIG. 96 is a rear elevation view depicting detail A of FIG. 94 showing the spacer retention pins in an extended position.

FIG. 97 is a top perspective view depicting one embodiment of a triple line spacer installation robot.

FIG. 98 is a bottom perspective view depicting the triple line spacer installation robot of FIG. 97.

FIG. 99 is a front elevation view depicting the triple line spacer installation robot of FIG. 97 with its left and right bogey support arms in a raised position prior to installation on a set of three wires.

FIG. 100 is a front elevation view depicting the triple line spacer installation robot of FIG. 99 with its left and right bogey support arms in a lowered position for mounting on a set of three wires.

FIG. 101 is a front elevation view depicting a prior art triple line spacer loosely installed on a set of three wires.

FIG. 102 is a top perspective view depicting the triple line spacer installation robot of FIG. 97 mounted on a set of three wires prior to installing a plurality of the prior art triple line spacers of FIG. 101.

FIG. 103 is a top perspective view depicting the triple line spacer installation robot of FIG. 102 moving towards the plurality of the prior art triple line spacers.

FIG. 104 is a top perspective view depicting the triple line spacer installation robot of FIG. 103 fully loaded with the prior art triple line spacers.

FIG. 105 is a top perspective view depicting the triple line spacer installation robot of FIG. 104 after having installed the plurality of the prior art triple line spacers.

FIG. 106 is a side elevation view depicting the triple line spacer installation robot of FIG. 97.

FIG. 107 is a front elevation view depicting the triple line spacer installation robot of FIG. 106 along section lines A-A.

FIG. 108 is a front elevation view depicting the triple line spacer installation robot of FIG. 107 with the left and right bogey support arms in an extended configuration.

FIG. 109 is a front elevation view depicting the triple line spacer installation robot of FIG. 108 with the left and right bogey support arms in a retracted configuration.

FIG. 110 is a rear elevation view depicting the triple line spacer installation robot of FIG. 97 prior to fastening the bolts of a triple line spacer.

FIG. 111 is a rear elevation view depicting the triple line spacer installation robot of FIG. 110 fastening the bolts of the triple line spacer.

FIG. 112 is a rear elevation view depicting the triple line spacer installation robot of FIG. 111 after installing the triple line spacer.

FIG. 113 is a rear elevation view depicting detail A of FIG. 112 showing the spacer retention pins in a retracted position.

FIG. 114 is a rear elevation view depicting detail A of FIG. 112 showing the spacer retention pins in an extended position.

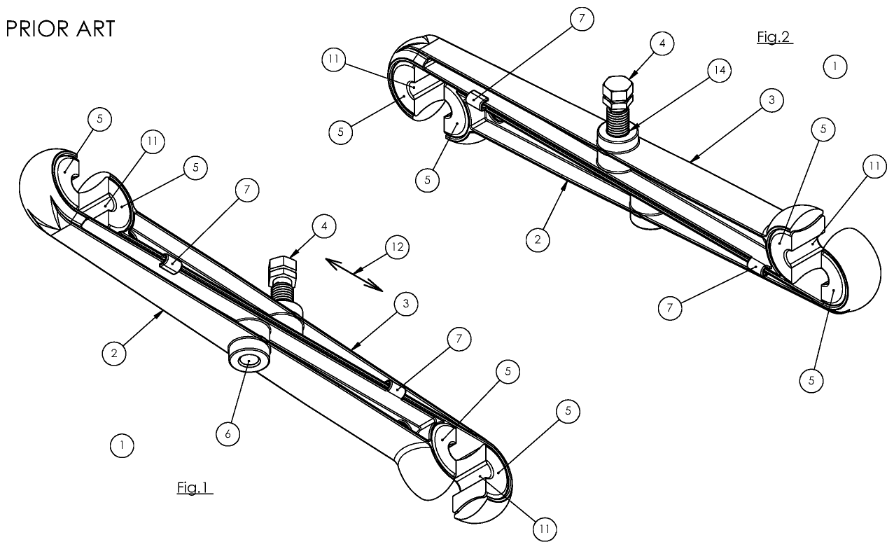

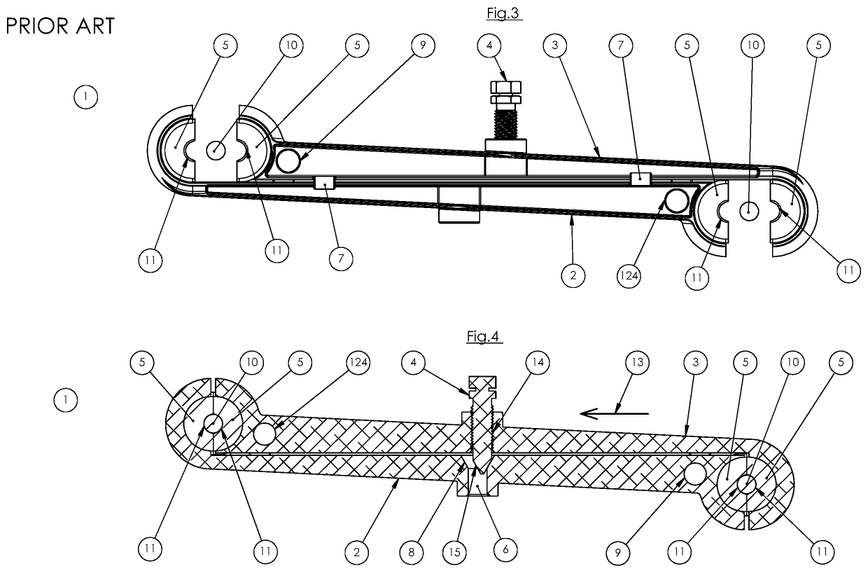

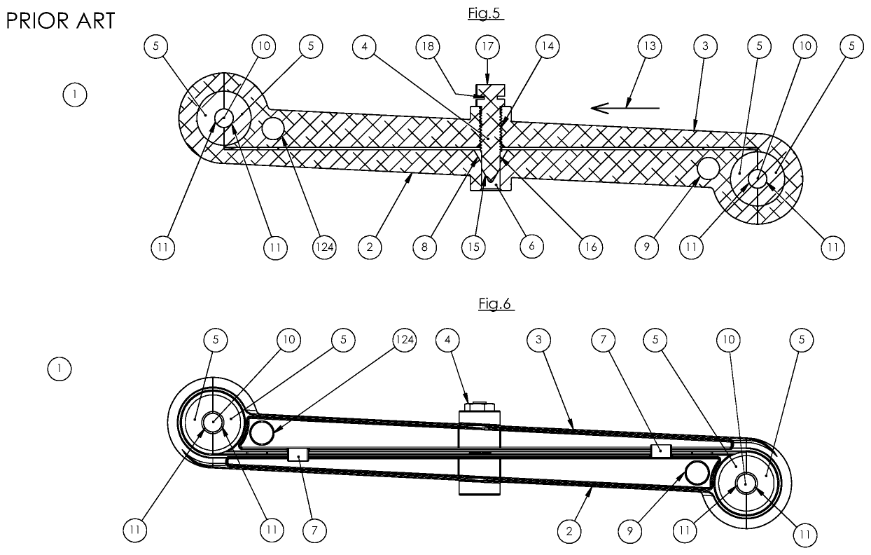

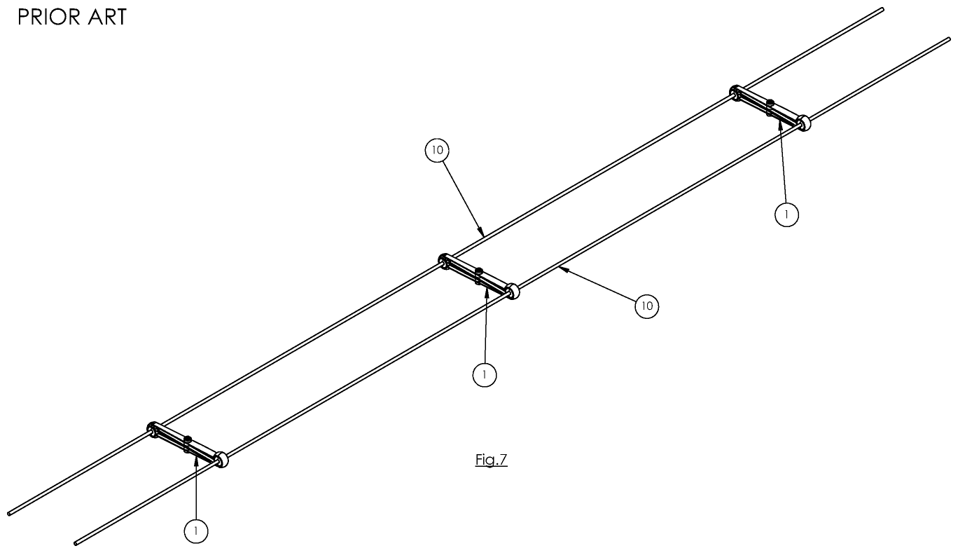

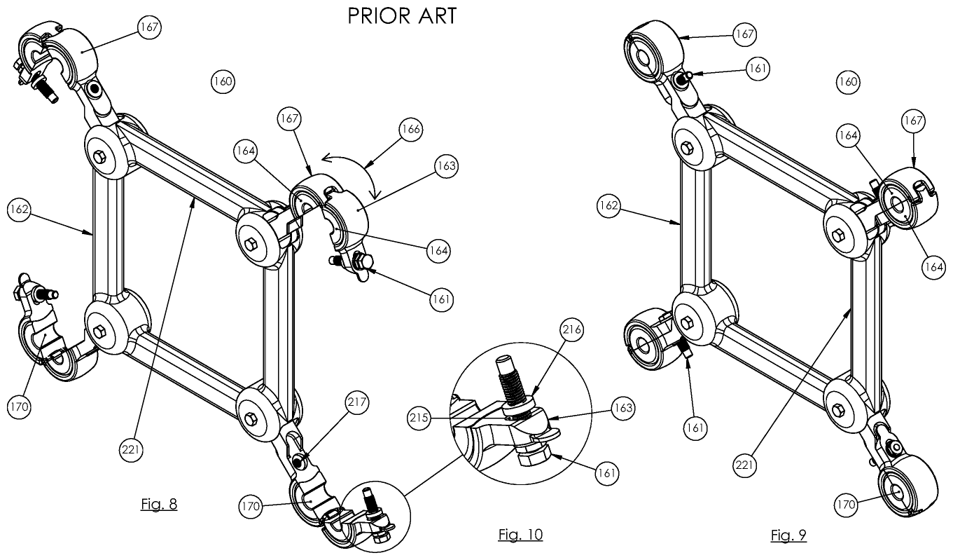

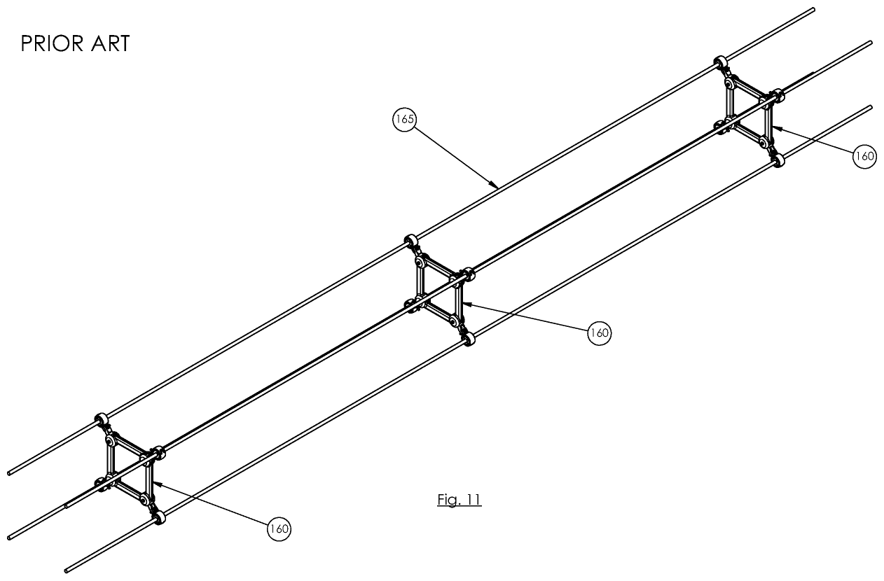

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments, but is not necessarily included. Thus, the present technology can include a variety of combinations and/or integrations of the embodiments described herein.

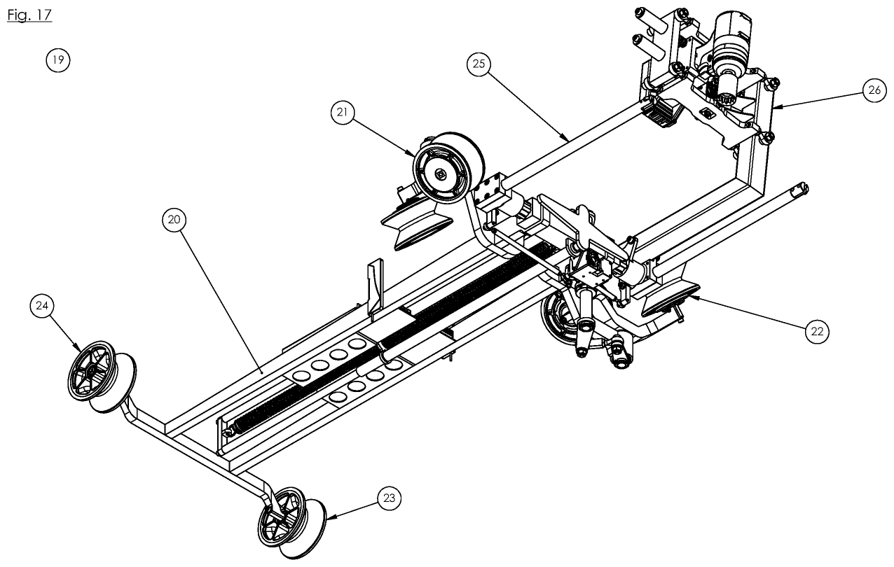

Starting at FIG. 16, FIG. 16 shows a forward upper perspective view and FIG. 17 shows a rear lower perspective view of one embodiment of dual line spacer installation robot 19 that can install a plurality of dual line spacers 1 to each dual conductor group of the power line, substantially equally spaced at a predetermined interval along each span, as depicted in FIG. 7. In some embodiments, robot 19 can comprise of frame 20, left hand wheel truck assembly 21, right hand wheel truck assembly 22, underside front wheel 23, overhead front wheel 24, magazine assembly 25, bolt tightening assembly 26, batteries 27, computer 28, radio modem 29, antennas 30 and ground station 31. In some embodiments, left hand wheel truck assembly 21, right hand wheel truck assembly 22 can each be fitted with a plurality of wheels 34 that can each comprise internal electric motors disposed therein that can be powered by batteries 27 that can allow robot 19 to traverse along wires 10 as commanded by computer 28. In some embodiments, wheels 34 can be physically configured to constrain or contact wires 10 such that robot 19 can be supported on wires 10 as well as to provide motive power to move robot 19 along wires 10. To operate robot 19, a human operator can use ground station 31 to send radio signals to one or more antennas 30, which can be connected to radio modem 29. Radio modem 29 can decode the radio signals from ground station 31 and can send these signals to computer 28 that, in turn, can send signals to the electrical equipment fitted to the robot, for example, electrically driven wheels and servo-actuators, to cause the robot 19 to complete its task of installing a plurality of dual line spacers 1 onto wires 10. The computer can, in some embodiments, be programmed to operate the robot automatically without operator input, or semi-automatically by taking cues from the human operator via the ground station 31 as desired.

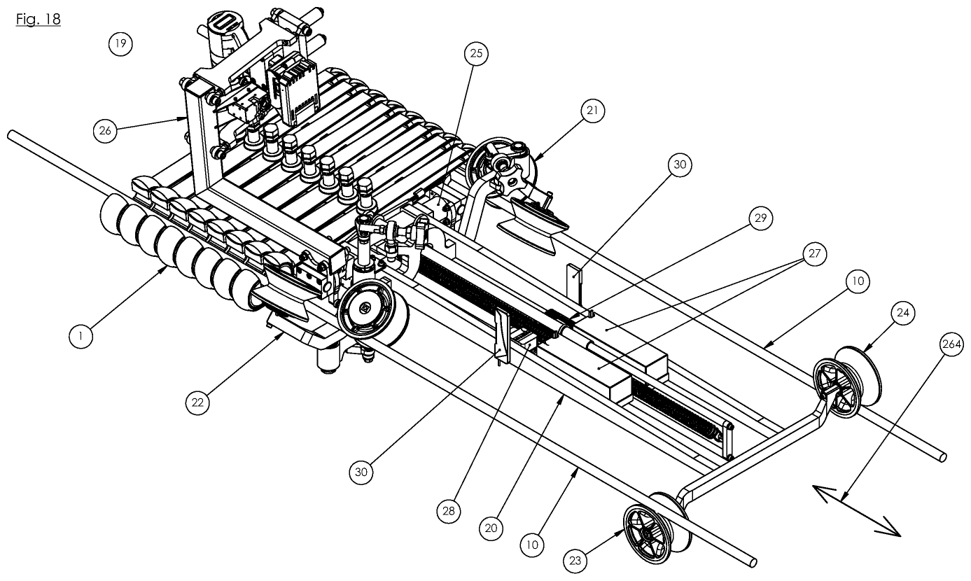

FIG. 18 shows a forward upper perspective view, and FIG. 19 shows a rear lower perspective view of, robot 19 installed on wires 10 after magazine assembly 25 has been filled with a plurality of dual line spacers 1. It can be seen that, thus configured, robot 19 can be free to travel down wires 10 in the direction of arrow 264 as desired by the operator as it rolls on left hand wheel truck assembly 21, right hand wheel truck assembly 22, underside front wheel 23 and overhead front wheel 24, all of which can be configured to engage wires 10 and, collectively, provide powered rolling movement along wires 10 while preventing robot 19 from inadvertently becoming disengaged with wires 10. In addition, left hand wheel truck assembly 21, right hand wheel truck assembly 22, underside front wheel 23, overhead front wheel 24 can be configured to align wires 10 with the plurality of dual line spacers 1 that have been loaded into magazine assembly 25. This can ensure repeatable and reliable engagement of dual line spacers 1 with wires 10 when magazine assembly 25 and bolt tightening assembly 26 are actuated to fasten each dual line spacer 1 to wires 10 at predetermined intervals as robot 19 travels along the length of wires 10.

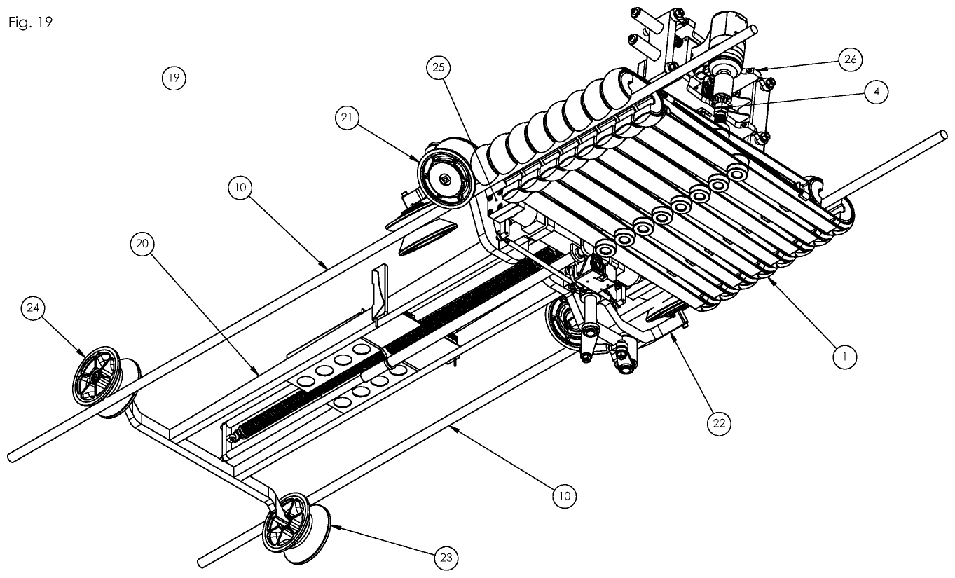

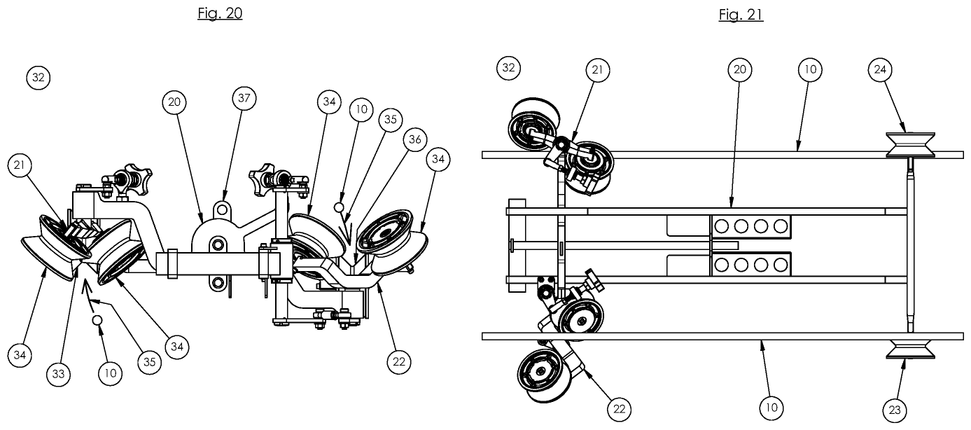

In order to firmly secure robot 19 to wires 10, while still allowing controlled rolling movement along wires 10, robot 19 can be manually moved into position by supporting it from lift point 37 with a suitable lifting device for example as a crane, bucket truck or helicopter, as well known to those skilled in the art, and attaching robot 19 to wires 10 by controlling the configuration of left hand wheel truck assembly 21 and right hand wheel truck assembly 22. FIG. 20 and FIG. 21 show a rear view and a top view, respectively, of frame 20, left hand wheel truck assembly 21, right hand wheel truck assembly 22, underside front wheel 23 and overhead front wheel 24. The remaining components of robot 19 are not shown for clarity. This group of components will be from hereon referred to as rolling chassis 32. FIGS. 20 and 21 depict rolling chassis 32 with left hand wheel truck assembly 21 configured in the open position so as to allow a wire 10 to be inserted by moving it in the direction of arrow 35 into gap 33 that exists between the plurality of wheels 34 that make up the rolling elements of left hand wheel truck assembly 21. In some embodiments, right hand wheel truck assembly 22 can be configured in the open position so as to allow a wire 10 to be inserted by moving it in the direction of arrow 35 into gap 36 that exists between the plurality of wheels 34 that make up the rolling elements of right hand wheel truck assembly 22.

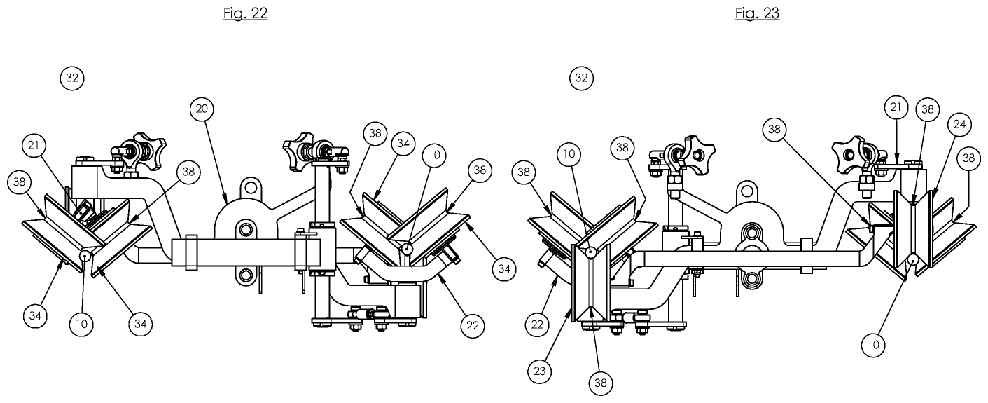

FIG. 22 and FIG. 23 show a rear view and a front view respectively of rolling chassis 32 with left hand wheel truck assembly 21 and right hand wheel truck assembly 22 configured in the closed position. It can be seen that a wire 10 is trapped underneath vee groove 38 that forms the outer circumference of overhead front wheel 24 such that overhead front wheel 24 can roll on top of a wire 10. A wire 10 is also trapped between the vee groove 38 that form the outer circumference of plurality of wheels 34 that make up the rolling elements of left hand wheel truck assembly 21. It can also be seen that a wire 10 is trapped above vee groove 38 that forms the outer circumference of underside front wheel 23 such that underside front wheel 23 can roll on top of a wire 10. A wire 10 is also trapped between the vee groove 38 that form the outer circumference of plurality of wheels 34 that make up the rolling elements of right hand wheel truck assembly 22. As shown in FIGS. 22 and 23, the rolling axis of wheels 34 fitted to left hand wheel truck assembly 21 and right hand wheel truck assembly 22 can, in some embodiments, be angled substantially from horizontal to provide a more effective trapping action of wires 10. Thus configured, robot 19 can be firmly affixed to wires 10 while allowing for smooth rolling movement along wires 10. Trapping wires 10 between the vee grooves 38 that form the outer circumference of the plurality of wheels described therein also ensures that the distance between the axis of both wires 10 can be kept relatively constant as robot 19 travels along the wires 10, allowing consistent alignment of the wires 10 with the magazine assembly 25 to ensure consistent and reliable installation of the plurality of dual line spacers 1.

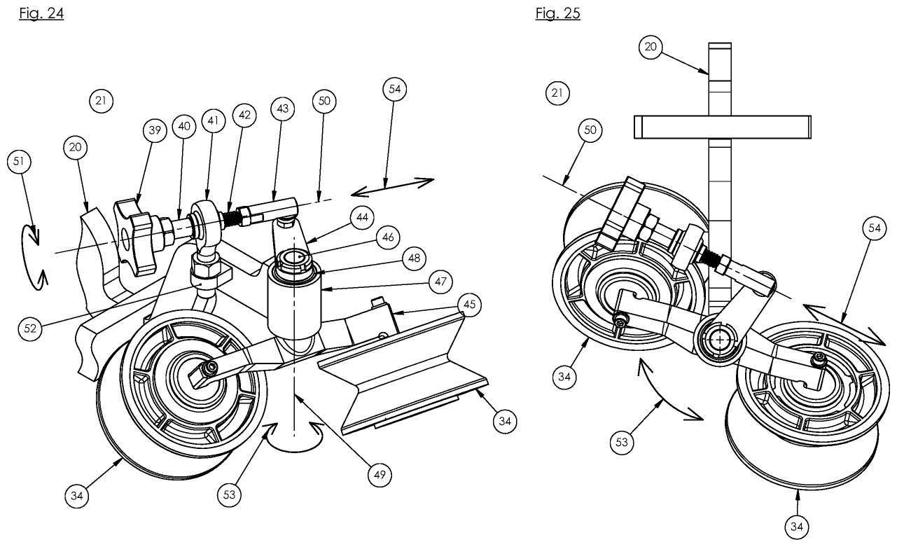

FIGS. 24 and 25 show perspective and top views respectively of the left hand wheel truck assembly 21 attached to a portion of frame 20. In some embodiments, left hand wheel truck assembly 21 can be comprised of knob 39, barrel 40, Heim joint 41, threaded shaft 42, rod end 43, crank arm 44, wheel frame 45 and a plurality of wheels 34. In some embodiments, wheels 34 can be fitted with internal electric motors that can be powered by batteries 27 to allow them to propel robot 19 along wires 10. The axles of wheels 34 can be attached to the extremities of wheel frame 45 as shown. In some embodiments, wheel frame 45 can be fitted with an axle 46 that can protrude upwards from a central location of wheel frame 45. Axle 46 can be fitted into one or more bearings 48 that can be fitted into barrel 47 which, in turn, can be attached to frame 20. This can allow wheel frame 45 and the attached plurality of wheels 34 to rotate about axis 49 with respect to frame 20 as depicted by arrow 53, allowing plurality of wheels 34 to trap wire 10 as depicted in FIGS. 20, 21, 22 and 23.

In order to control the rotational angle of wheel frame 45 and the attached plurality of wheels 34 about axis 49, the upper extremity of axle 46 can be fitted with crank arm 44 that can protrude radially outwards from axis 49. The extremity of crank arm 44 can be attached to rod end 43, which can be attached to threaded shaft 42. The external circumference of threaded shaft 42 can be threaded to allow it to thread into barrel 40. In some embodiments, knob 39 can be attached to barrel 40 such that a human operator can grasp knob 39 and rotate it and the attached barrel 40 about axis 50 as depicted by arrow 51. Barrel 10 can be fixed into the internal bore of the ball joint of Heim joint 41. The body of Heim joint 41 can be securely attached to frame 20 by threading into lug 52. In some embodiments, threaded shaft 42 can be threaded into barrel 40 and, thus, rotation of threaded shaft 42 about axis 50 can be prevented from occurring due to the configuration of the internal ball joint that connects the two main parts of rod end 43, as well known to those skilled in the art. Thus configured, when the human operator rotates knob 39 about axis 50, barrel 40 can also rotate about axis 50, causing threaded shaft 42 to be drawn into, or pushed out of, the interior of barrel 40 in the direction of arrow 54 through the interaction of the female internal thread of barrel 40 with the matching male thread that makes up the external circumference of threaded shaft 42. This linear motion can be transmitted into the outer extremity of crank arm 44 via rod end 43, which can be fitted with an internal ball joint to allow for substantial rotation of crank arm 44 with respect to threaded shaft 42 as crank arm 44 rotates about axis 49.

In some embodiments, Heim joint 41 can allow barrel 40 to rotate smoothly about axis 50 while transmitting thrust loads from barrel 40 into frame 20, as well as allowing for slight misalignment of barrel 40, as axis 50 can be angularly displaced with respect to frame 20 as crank arm 44 rotates about axis 49.

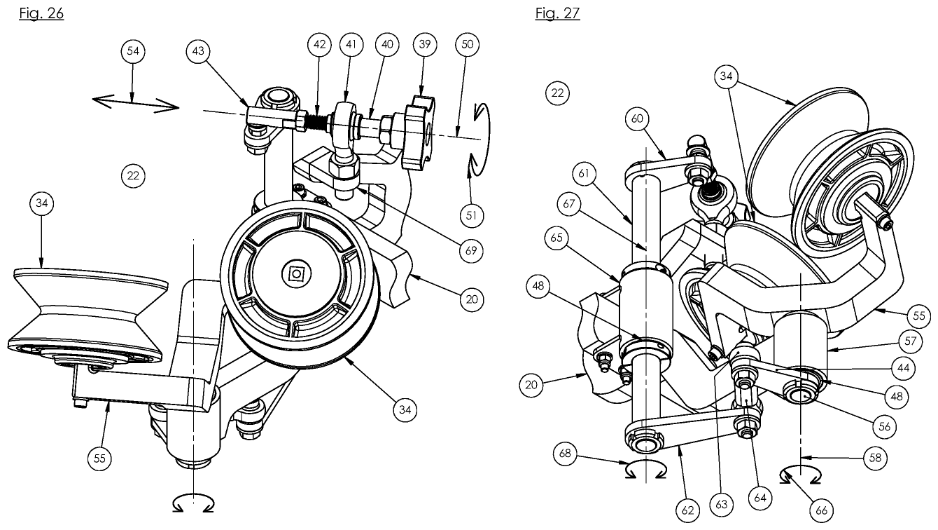

FIGS. 26 and 27 show upper perspective and lower perspective views respectively of the right hand wheel truck assembly 22 attached to a portion of frame 20. In some embodiments, right hand wheel truck assembly 22 can be comprised of knob 39, barrel 40, Heim joint 41, threaded shaft 42, rod end 43, upper crank arm 60, intermediate axle 61, long crank arm 62, male Heim joint 63, female Heim joint 64, crank arm 44, wheel frame 55 and a plurality of wheels 34. In some embodiments, wheels 34 can be fitted with internal electric motors to allow them to propel robot 19 along Wires 10. The axles of wheels 34 can be attached to the extremities of wheel frame 55 as shown. In some embodiments, wheel frame 55 can be fitted with an axle 56 which can protrude downwards from a central location of wheel frame 55. In some embodiments, axle 56 can be fitted into one or more bearings 48 that can be fitted into barrel 57 that, in turn, can be attached to frame 20. This can allows wheel frame 55 and the attached plurality of wheels 34 to rotate about axis 58 with respect to frame 20 as depicted by arrow 66, allowing plurality of wheels 34 to trap wire 10 as depicted in FIGS. 20, 21, 22 and 23.

In order to control the rotational angle of wheel frame 55 and the attached plurality of wheels 34 about axis 58, the lower extremity of axle 56 can be fitted with crank arm 44 that can protrude radially outwards from axis 58. The extremity of crank arm 44 can be attached to the spherical bearing portion of female Heim joint 64. The body of female Heim joint 64 can be attached to the body of male Heim joint 63. The spherical bearing portion of male Heim joint 64 can be attached to the outer extremity of long crank arm 62. The inner extremity of long crank arm 62 can be attached to the lower extremity of intermediate axle 61. In some embodiments, upper crank arm 60 can be attached to the upper extremity of intermediate axle 61. In some embodiments, intermediate axle 61 can be fitted into one or more bearings 48 that can, in turn, be fitted into barrel 65. In some embodiments, barrel 65 can be attached to frame 20. This can allow intermediate axle 61, long crank arm 62 and upper crank arm 60 to rotate about axis 67 with respect to frame 20 as depicted by arrow 68. In some embodiments, rotation of upper crank arm 60 about axis 67 can result in the rotation of long crank arm 62 about axis 67 that, due to the connection of long crank arm 62 to crank arm 44 via female Heim joint 64 and male Heim joint 64, can cause wheel frame 55 and the attached plurality of wheels 34 to rotate about axis 58 in the opposite direction to the rotation of intermediate shaft 61.

In some embodiments, the external circumference of threaded shaft 42 can be threaded to allow it to thread into barrel 40. In some embodiments, knob 39 can be attached to barrel 40 such that a human operator can grasp knob 39 and rotate it and the attached barrel 40 about axis 50 as depicted by arrow 51. In some embodiments, barrel 10 can be fixed into the internal bore of the ball joint of Heim joint 41. In some embodiments, the body of Heim joint 41 can be securely attached to frame 20 by threading into lug 69. In some embodiments, threaded shaft 42 can be threaded into barrel 40 and rotation of threaded shaft 42 about axis 50 can be prevented from occurring due to the configuration of the internal ball joint that connects the two main parts of rod end 43. Thus configured, when the human operator rotates knob 39 about axis 50, barrel 40 can also rotate about axis 50, causing threaded shaft 42 to be drawn into, or pushed out of, the interior of barrel 40 in the direction of arrow 54 through the interaction of the female internal thread of barrel 40 with the matching male thread that makes up the external circumference of threaded shaft 42. This linear motion can be transmitted into the outer extremity of upper crank arm 60 via rod end 43, which can be fitted with an internal ball joint to allow for substantial rotation of crank arm 44 with respect to threaded shaft 42 as crank arm 44 rotates about axis 49.

In some embodiments, Heim joint 41 can allow barrel 40 to rotate smoothly about axis 50 while transmitting thrust loads from barrel 40 into frame 20, as well as allowing for slight misalignment of barrel 40, as axis 50 will be angularly displaced with respect to frame 20.

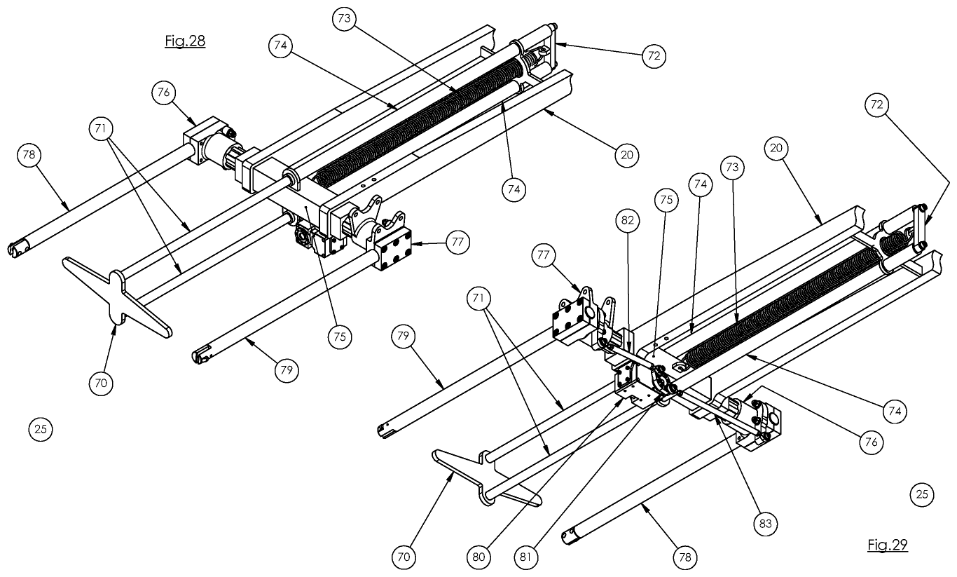

FIGS. 28 and 29 show upper perspective and lower perspective views respectively of magazine assembly 25 attached to a portion of frame 20. In some embodiments, magazine assembly 25 can comprise of pusher 70, pusher rods 71, backing plate 72, spring 73, pusher guides 74, female spline block 75, right hand rod carrier 77, left hand rod carrier 76, right hand magazine rod 79, left hand magazine rod 78, rotary servo-actuator 80, crank arm 81, right hand tie rod 82 and left hand tie rod 83.

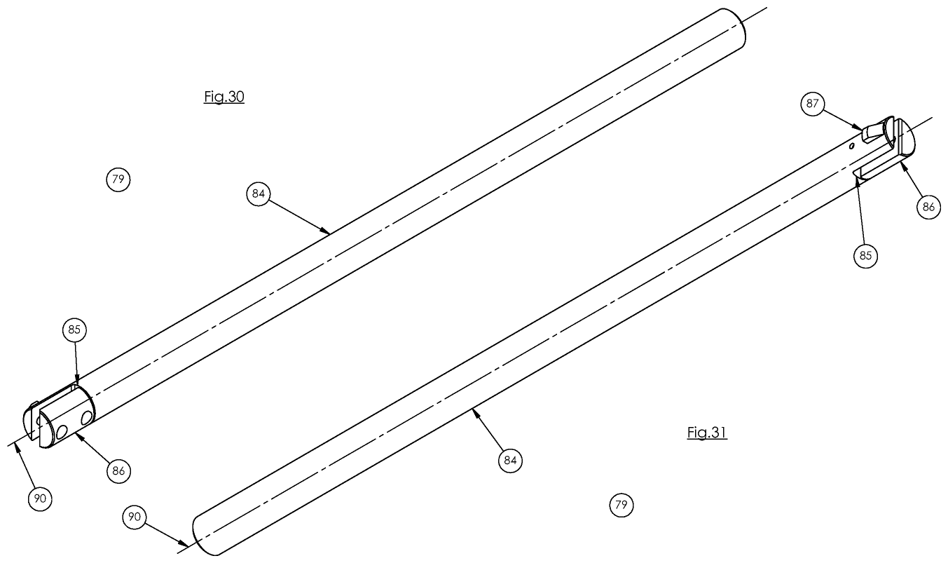

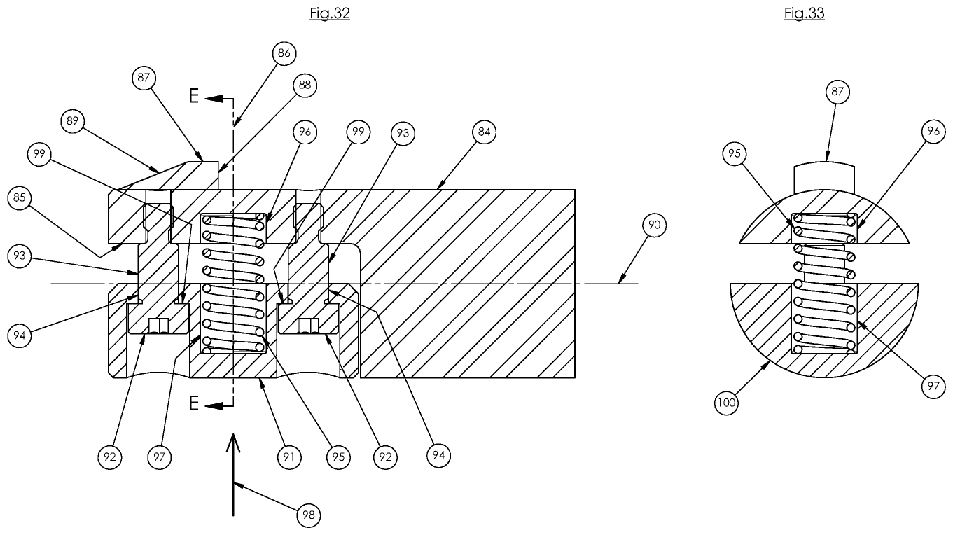

FIGS. 30 and 31 show upper perspective and lower perspective views respectively of right hand magazine rod 79, which can be identical in construction to left hand magazine rod 78. FIG. 32 shows a detail view of the mechanism fitted to the end of right hand magazine rod 79, sectioned through the horizontal plane and coincident with axis 90 of cylindrical right hand magazine rod 79. FIG. 33 shows a detail view of the same mechanism, sectioned through vertical plane 86. In some embodiments, right hand magazine rod 79 can comprise of cylindrical rod 84 further comprising cut recess 85. Rod 84 can also be fitted with stop catch 87, which can comprise of catch 88 and loading ramp 89. Catch 88 can be a facet of stop catch 87 that, in some embodiments, can be substantially perpendicular to axis 90 of cylindrical right hand magazine rod 79. Recess 85 can house detent block 91 that, in some embodiments, can be secured to rod 84 with shoulder bolts 92 wherein shoulders 93 thereof can pass through holes 94. Holes 94 can be sized in such a way as to provide free sliding motion of detent block 91 on shoulders 93 of shoulder bolts 92 in the direction of arrow 98. In some embodiments, compression spring 95 can be housed in the gap that exists between pocket 96, which is cut into rod 84, and pocket 97, which is cut into detent block 91. When the mechanism shown in FIGS. 32 and 33 is at rest, compression force from compression spring 95 can act on the base of pocket 97 in a direction opposite to arrow 98 and can force shoulders 99 to rest against the underside of the heads of shoulder bolts 92. As shown in FIG. 33, in this configuration, outer cylindrical surface 100 can be configured to be substantially co-radial as well as substantially equal in diametrical size with the outer cylindrical surface of rod 84, such that the overall cylindrical shape and size of right hand magazine rod 79 can continue unbroken throughout the whole length of right hand magazine rod 79.

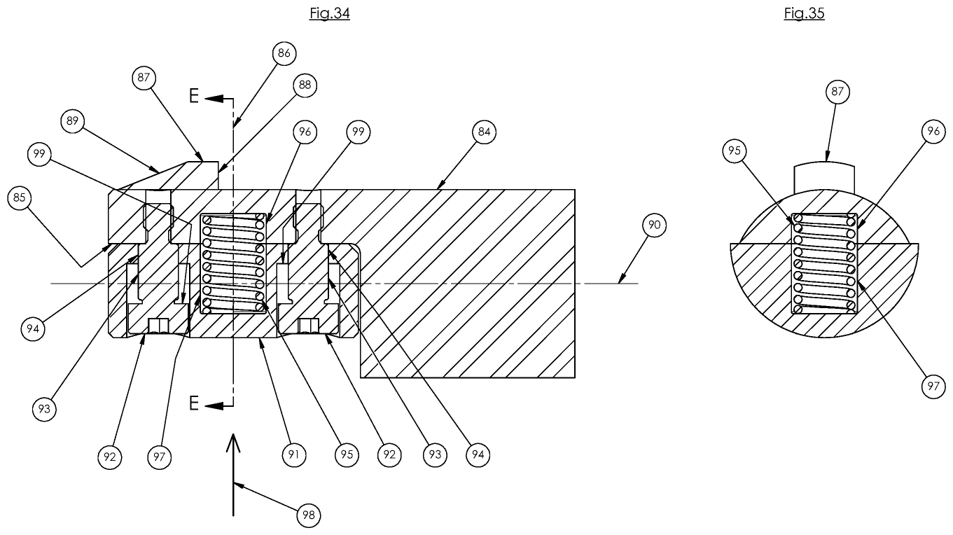

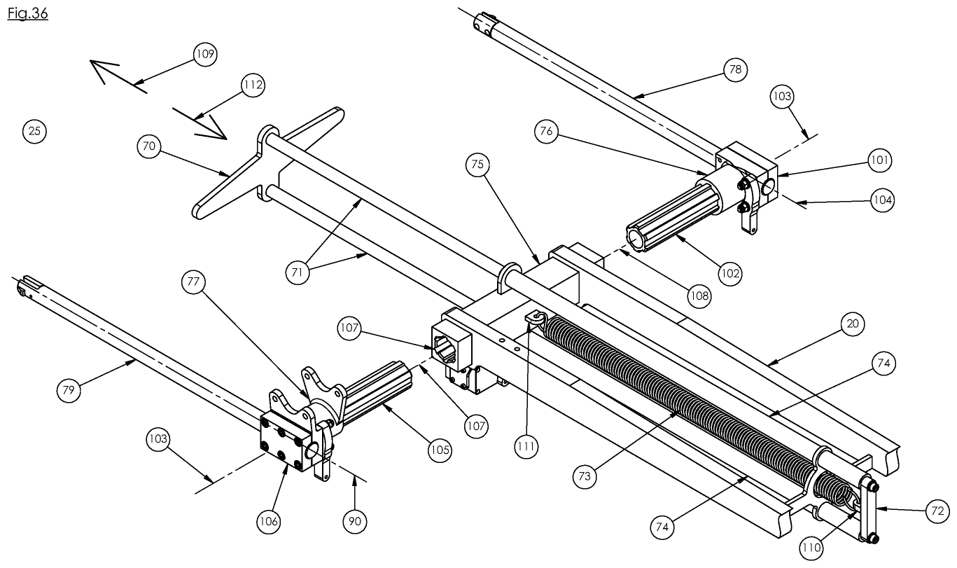

In some embodiments, applying a force to detent block 91 in the direction of arrow 98 that exceeds the compressive force in compression spring 95 can cause detent block 91 to move in the direction of arrow 98 until detent block 91 contacts the back of recess 85. FIG. 34 and FIG. 35 show the same views and components as FIG. 30 and FIG. 31, but with detent block 91 fully depressed against the force of compression spring 95 until detent block 91 has contacted the back of recess 85 wherein no further movement of detent block 91 with respect to rod 84 can occur.

In some embodiments, the components that make up right hand magazine rod 79 and left hand magazine rod 78, and the mechanical operations of these components as described, can be used to control the loading and unloading of magazine assembly 25 with a plurality of dual line spacers 1 to allow for reliable and repeatable installation of dual line spacers 1 onto wires 10.

FIG. 36 shows an upper perspective view of magazine assembly 25 attached to a portion of frame 20, with right hand rod carrier 77 and left hand rod carrier 76 disassembled from female spline block 75. In some embodiments, female spline block 75 can form an integral part of Frame 20. In some embodiments, left hand magazine rod 78 can be clamped to left hand rod carrier 76 with clamp plate 101. In some embodiments, left hand rod carrier 76 can be fitted to splined shaft 102 in such a way as to make axis 104 of left hand magazine rod 78 substantially perpendicular to axis 103 of splined shaft 102. In some embodiments, right hand magazine rod 79 can be clamped to right hand rod carrier 77 with clamp plate 106. In some embodiments, right hand rod carrier 77 can be fitted to splined shaft 105 in such a way as to make axis 90 of right hand magazine rod 79 substantially perpendicular to axis 103 of splined shaft 105.

In some embodiments, female spline block 75 can be furnished with an internal female spline 107 that can pass horizontally through the length of female spline block 75. In some embodiments, female spline 107 can be configured in such a way as to closely match the form of the male spline that form the outer circumference of splined shaft 102 and splined shaft 105. Thus configured, splined shaft 102 and splined shaft 105 can be inserted into either end of female spline block 75 as depicted by line 107 and line 108. Thus configured, splined shaft 102 and splined shaft 105 can freely slide in and out of female spline block 75 along the direction of axis 103, while rotation of splined shaft 102 and splined shaft 105 about axis 103 can be prevented by the interaction of the external spline form of splined shaft 102 and splined shaft 105 with the internal spline form of female spline block 75.

The external spline form of splined shaft 102 and splined shaft 105 and the internal spline form of female spline block 75 can be constructed in such a way such that, when assembled, axis 90 of right hand magazine rod 79 and axis 104 of left hand magazine rod 78 can be oriented substantially horizontally with respect to frame 20.

FIG. 36 also shows pusher 70 attached to a plurality of pusher rods 71, which can be inserted into a corresponding plurality of pusher guides 74 that form part of frame 20. In some embodiments, backing plate 72 can be fastened to the extremities of pusher rods 71 and, after assembly, can prevent pusher rods 71 and pusher 70 from moving any further in the direction of arrow 109. In some embodiments, spring 73 can be connected to backing plate 72 via lug 110, and the opposing end of spring 73 can be connected to frame 20 via lug 111. Thus configured, when resting, spring 73 can pull backing plate 72 and attached components pusher rods 71 and pusher 70 in the direction of arrow 109 until backing plate 72 contacts the ends of pusher guides 74. In some embodiments, pusher rods 71 can be configured to slide with very little friction inside pusher guides 74, such that provided the magnitude of the applied force is sufficient to overcome the tension force in spring 73, application of force to pusher 70 in the direction of arrow 112 can move pusher 70 and attached parts pusher rods 71 and backing plate 72 in the direction of arrow 112 until pusher 70 contacts frame 20 and motion ceases.

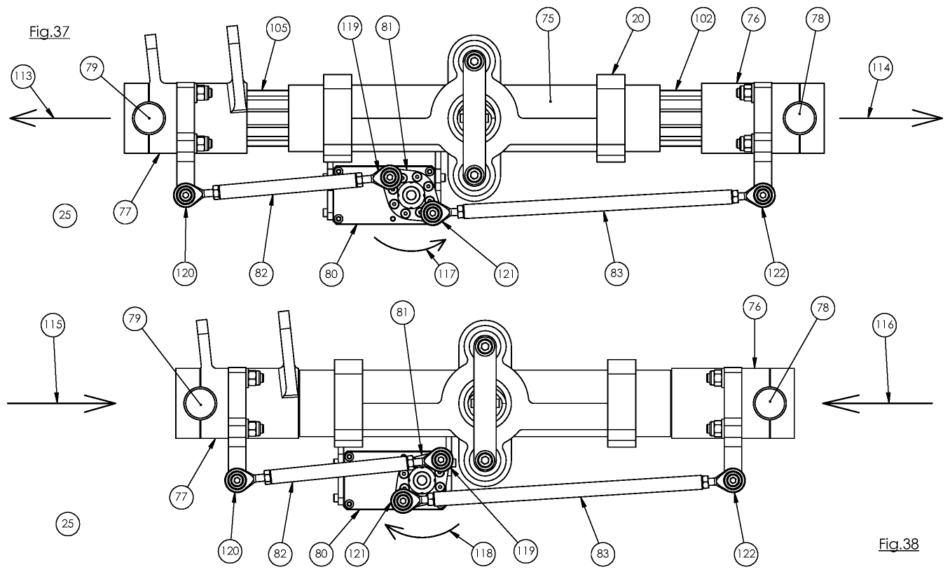

FIG. 37 and FIG. 38 depict a front view of magazine assembly 25 showing frame 20, right hand rod carrier 77, left hand rod carrier 76, right hand magazine rod 79, left hand magazine rod 78, rotary servo-actuator 80, crank arm 81, right hand tie rod 82 and left hand tie rod 83. FIG. 37 depicts rotary servo-actuator 80 attached to frame 20 configured such that left hand magazine rod 78 has been moved outwards with respect to frame 20 in the direction of arrow 113 and right hand magazine rod 79 has been moved outwards with respect to frame 20 in the direction of arrow 114. FIG. 38 depicts rotary servo-actuator 80 attached to frame 20 configured such that left hand magazine rod 78 has been moved inwards with respect to frame 20 in the direction of arrow 115 and right hand magazine rod 79 has been moved inwards with respect to frame 20 in the direction of arrow 116.

Control of the movement of left hand magazine rod 78 in the directions of arrow 113 and 115, and right hand magazine rod 79 in the directions of arrow 114 and 116, can be achieved by controlling the rotation of crank arm 81 which can be attached to the output shaft of rotary servo-actuator 80. In some embodiments, right hand tie rod 82 can be fitted with Heim joint 119 on the inboard end, and Heim joint 120 on the outboard end. Heim joint 119 can be attached to crank arm 81 at a point substantially radially offset from and substantially above the axis of rotation of crank arm 81, and Heim joint 120 can be attached to left hand rod carrier 76. Thus configured, rotary motion of crank arm 81 in the direction of arrow 117 can cause a motion of left hand rod carrier 76 and all attached components in the direction of arrow 113.

In some embodiments, left hand tie rod 83 can be fitted with Heim joint 121 on the inboard end, and Heim joint 122 on the outboard end. Heim joint 121 can be attached to crank arm 81 at a point substantially radially offset from and substantially below the axis of rotation of crank arm 81, and Heim joint 122 can be attached to right hand rod carrier 77. Thus configured, rotary motion of crank arm 81 in the direction of arrow 117 can cause a motion of right hand rod carrier 77 and all components attached to right hand rod carrier 77 in the direction of arrow 114.

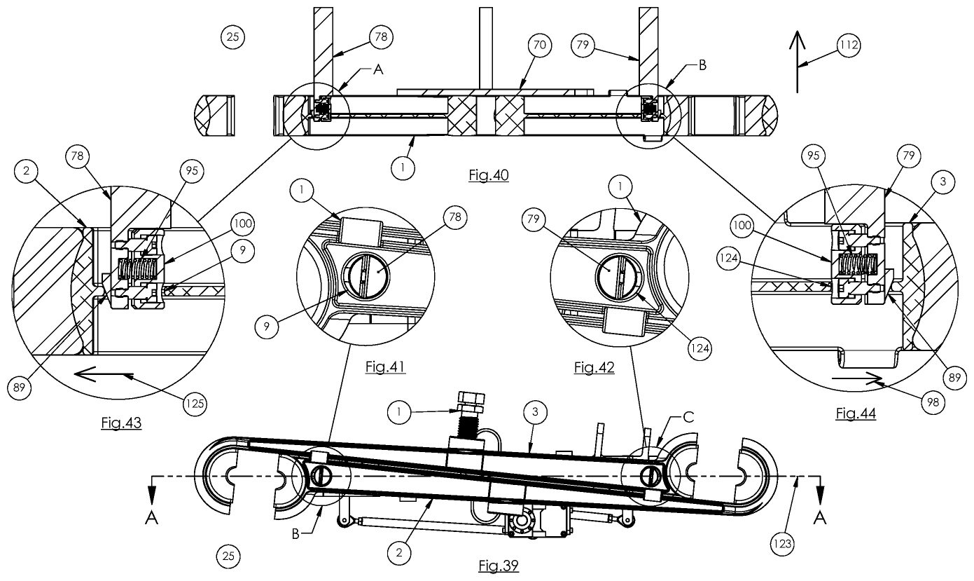

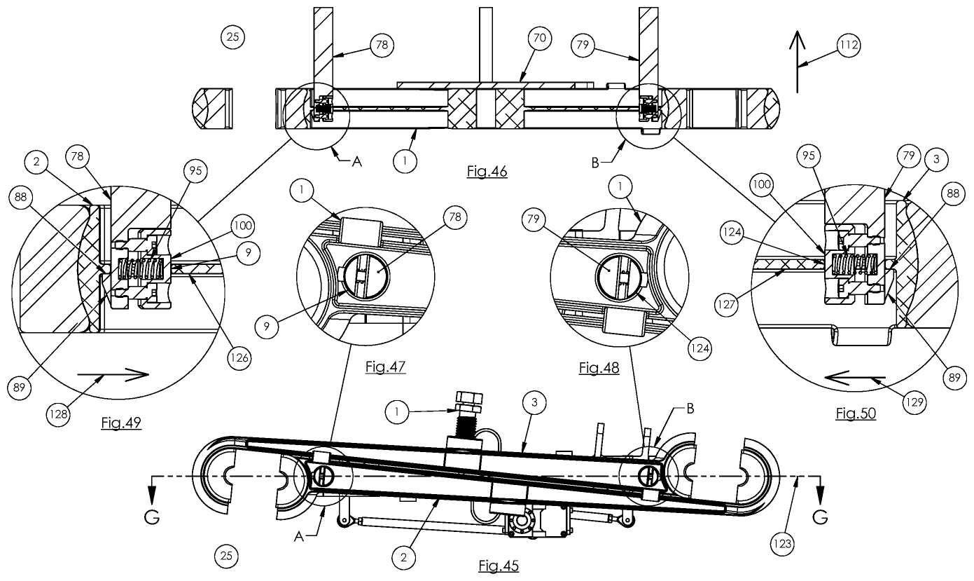

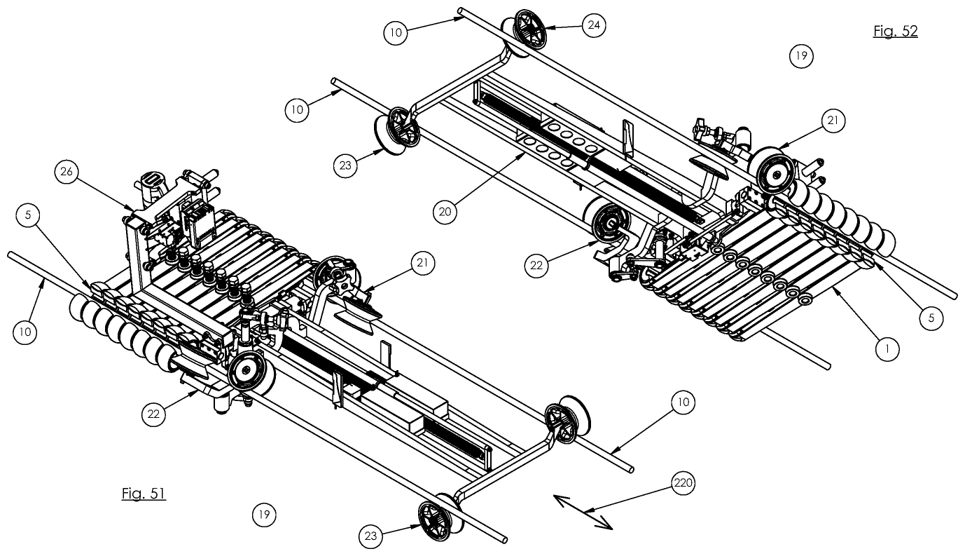

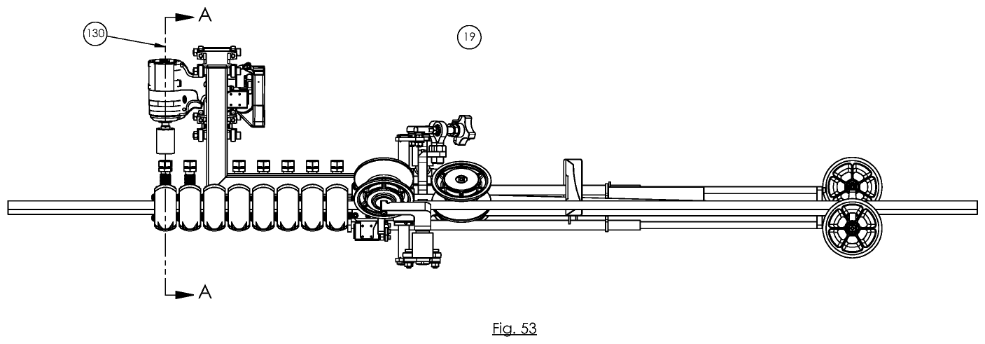

FIGS. 39-44 show the first step required to load magazine assembly 25 with a plurality of dual line spacers 1. FIG. 40 shows a rear view of magazine assembly 25 with a single dual line spacer 1 being loaded into magazine assembly 25. FIG. 40 shows a cropped section view of FIG. 39 with the section plane depicted by line 123. FIG. 41 is a detail view of FIG. 39 showing left hand magazine rod 78 being inserted into hole 9 which passes through dual line spacer 1, and FIG. 42 is a detail view of FIG. 39 showing right hand magazine rod 79 being inserted into hole 124, which passes through dual line spacer 1. FIG. 43 shows a detail view of FIG. 40 showing how the mechanism fitted to the end of left hand magazine rod 78 interacts with hole 9 which passes through dual line spacer 1. FIG. 44 shows a detail view of FIG. 40 showing how the mechanism fitted to the end of right hand magazine rod 79 interacts with hole 124 which passes through dual line spacer 1.

As shown in FIG. 39, the first step of loading magazine assembly 25 with a plurality of dual line spacers 1 can be done by manually grasping dual line spacer 1, and orienting dual line spacer 1 as shown. The protruding end of left hand magazine rod 78 can then be inserted into hole 9 in dual line spacer 1, and the protruding end of right hand magazine rod 79 can then be inserted into hole 124 in dual line spacer 1.

As seen in FIG. 43, as dual line spacer 1 is pushed onto magazine assembly 25, the outer circumference of hole 9 can ride up the angled surface of loading ramp 89, forcing lower body 2 of dual line spacer 1 to move in the direction of arrow 125. As this happens, the outer circumference of hole 9 can push against the cylindrical surface 100 of detent block 91 and can force detent block 91 to also move in the direction of arrow 125, compressing compression spring 95. This motion can provide adequate clearance to allow dual line spacer 1 to continue to be pushed onto magazine assembly 25.

As seen in FIG. 44, as dual line spacer 1 is pushed onto magazine assembly 25, the outer circumference of hole 124 can ride up the angled surface of loading ramp 89, forcing upper body 3 of dual line spacer 1 to move in the direction of arrow 98. As this happens, the outer circumference of hole 9 can push against the cylindrical surface 100 of detent block 91 and can force detent block 91 to also move in the direction of arrow 98, compressing compression spring 95. This motion can provide adequate clearance to allow dual line spacer 1 to continue to be pushed onto magazine assembly 25.

FIGS. 45-50 show the second step required to load magazine assembly 25 with a plurality of dual line spacers 1. FIG. 45 shows a rear view of magazine assembly 25 after a single dual line spacer 1 has been loaded into magazine assembly 25. FIG. 46 shows a cropped section view of FIG. 45 with the section plane depicted by line 123. FIG. 47 is a detail view of FIG. 45 showing how left hand magazine rod 78 has been inserted into hole 9 which passes through dual line spacer 1 and FIG. 48 is a detail view of FIG. 45 showing how right hand magazine rod 79 has been inserted into hole 124 which passes through dual line spacer 1. FIG. 49 shows a detail view of FIG. 46 showing how the mechanism fitted to the end of left hand magazine rod 78 interacts with hole 9 which passes through dual line spacer 1. FIG. 50 shows a detail view of FIG. 46 showing how the mechanism fitted to the end of right hand magazine rod 79 interacts with hole 124 which passes through dual line spacer 1.

FIGS. 45-50 show dual line spacer 1 after it has been fully loaded into magazine assembly 25. In this configuration, FIG. 49 shows how the motion of pushing dual line spacer 1 onto magazine assembly 25, as shown in FIGS. 39-44, has been continued until face 126 of lower body 2 has moved past catch 88, which is a facet of stop catch 87 of right hand magazine rod 79. Once this has occurred, compression force from compression spring 95 can move detent block 91 in the direction of arrow 128, therefore also moving lower body 2 in the direction of arrow 128 through the force of cylindrical surface 100 of detent block 91 pushing on the outer circumference of hole 9. Once detent block 91 has moved as far as possible in the direction of arrow 128, it can be seen that face 126 of lower body 2 can be trapped behind catch 88, which is a facet of stop catch 87. This can prevent force from pusher 70 from moving dual line spacer 1 in the opposite direction to arrow 112, securing dual line spacer 1 to magazine assembly 25. In addition, cylindrical surface 100 of detent block 91 can now be substantially coaxial with the outer cylindrical surface of left hand magazine rod 78, such that the overall cylindrical shape and size of left hand magazine rod 78 continues unbroken along the whole length of left hand magazine rod 78. This can allow dual line spacer 1 to be pushed further onto left hand magazine rod 78 as additional dual line spacers 1 are loaded into magazine assembly 25.

FIG. 50 shows how the motion of pushing dual line spacer 1 onto magazine assembly 25, as shown in FIGS. 39-44, has been continued until face 127 of upper body 3 has moved past catch 88, which is a facet of stop catch 87 of right hand magazine rod 79. Once this has occurred, compression force from compression spring 95 can move detent block 91 in the direction of arrow 129, therefore also moving upper body 3 in the direction of arrow 129 through the force of cylindrical surface 100 of detent block 91 pushing on the outer circumference of hole 9. Once detent block 91 has moved as far as possible in the direction of arrow 129, it can be seen that face 127 of upper body 3 is trapped behind catch 88, which is a facet of stop catch 87. This can prevent force from pusher 70 from moving dual line spacer 1 in the opposite direction to arrow 112, securing dual line spacer 1 to magazine assembly 25. In addition, cylindrical surface 100 of detent block 91 can now be substantially coaxial with the outer cylindrical surface of right hand magazine rod 79, such that the overall cylindrical shape and size of right hand magazine rod 79 continues unbroken along the whole length of right hand magazine rod 79. This can allow dual line spacer 1 to be pushed further onto right hand magazine rod 79 as additional dual line spacers 1 are loaded into magazine assembly 25.

To load more dual line spacers 1 into magazine assembly 25, the actions depicted in FIGS. 39-50 can be repeated in the same manner with additional dual line spacers 1, with the only difference being that additional dual line spacers 1 do not directly contact pusher 70, rather, they contact the previous dual line spacer 1 that was installed.

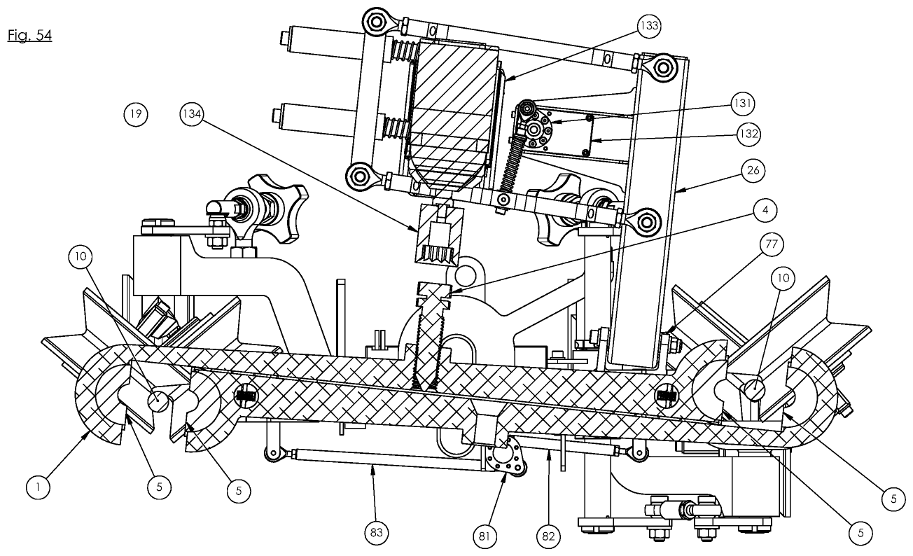

Once magazine assembly 25 of robot 19 has been loaded with a sufficient quantity of dual line spacers 1, rotary servo-actuator 81 can be rotated to the position shown in FIG. 38. Robot 19 can then be hoisted into position on wires 10. In some embodiments, underside front wheel 23 can be positioned under one of the wires 10, and knob 39 of right hand wheel truck assembly 22 can be rotated by the human operator in such a way as to lock the same wire 10 into right hand wheel truck assembly 22. In some embodiments, overhead front wheel 24 can be positioned on the other wires 10, and knob 39 of left hand wheel truck assembly 21 can be rotated by the human operator in such a way as to lock the same wire 10 into left hand wheel truck assembly 21. The resultant configuration of robot 19, loaded dual line spacers 1 and installed on wires 10, is shown in FIG. 51 and FIG. 52. Thus configured, wires 10 can now be located within and substantially centered in the gaps that exist between wire retaining block 5 of the plurality of dual line spacers 1, and do not physically contact wire retaining block 5 or any other part of the plurality of dual line spacers 1 that have been loaded into magazine assembly 25. This is shown in FIG. 54. Thus configured, robot 19 can now be securely attached to wires 10, and wheels 34 are able to power robot 19 in such a way as to move it along the axis of wires 10 in the direction of arrow 220 as desired.

FIGS. 54-58 show section views of robot 19, viewed from the rear and sectioned through line 130 shown in FIG. 53. Once robot 19 has been moved into position to install the first of the plurality of dual line spacers 1, the configuration of robot 19 prior to beginning installation of the first dual line spacer 1 is shown in FIG. 54. In this configuration, crank arm 81 can be oriented by rotary servo-actuator 80 (not shown for clarity) into the position shown such that substantial gaps exists between wire retaining blocks 5 and wires 10 are located within and substantially centered in these gaps. Crank arm 131, which is connected to the output shaft of rotary servo-actuator 132, can be positioned such that impact wrench 133 and socket 134 are raised such that a significant gap exist between socket 134 and clamping bolt 4.

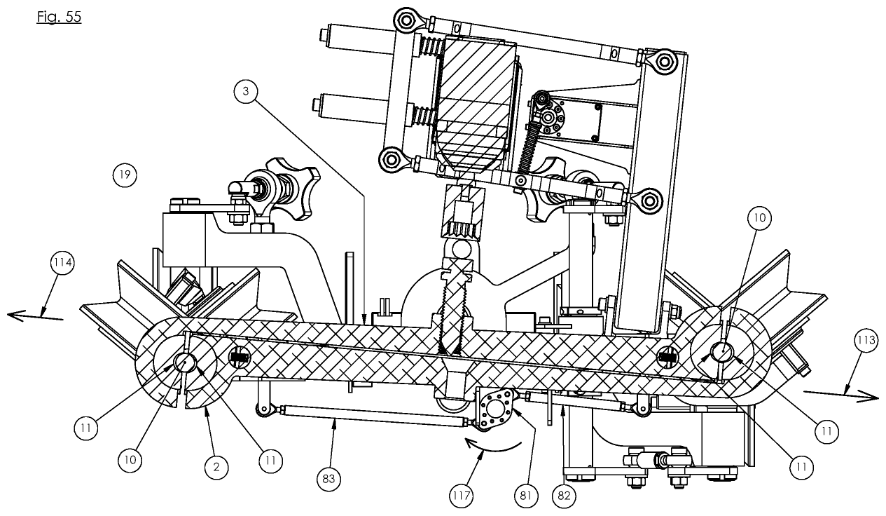

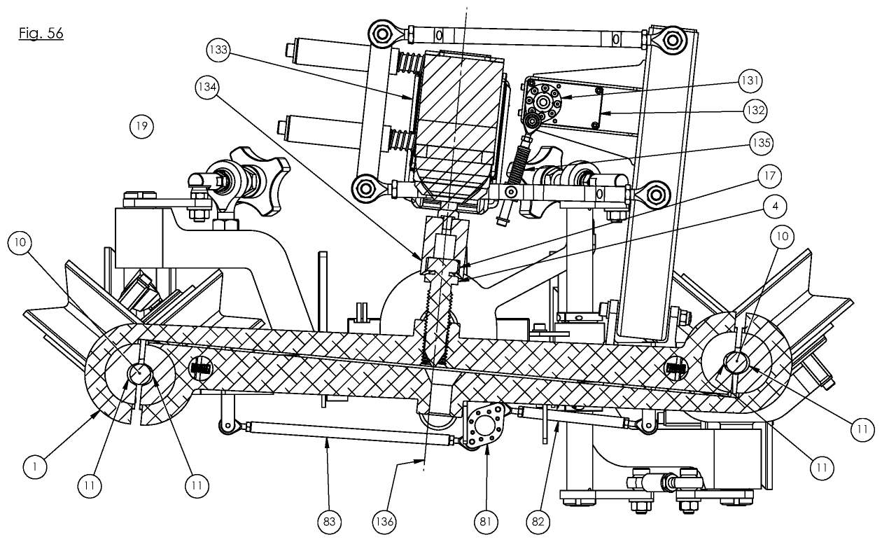

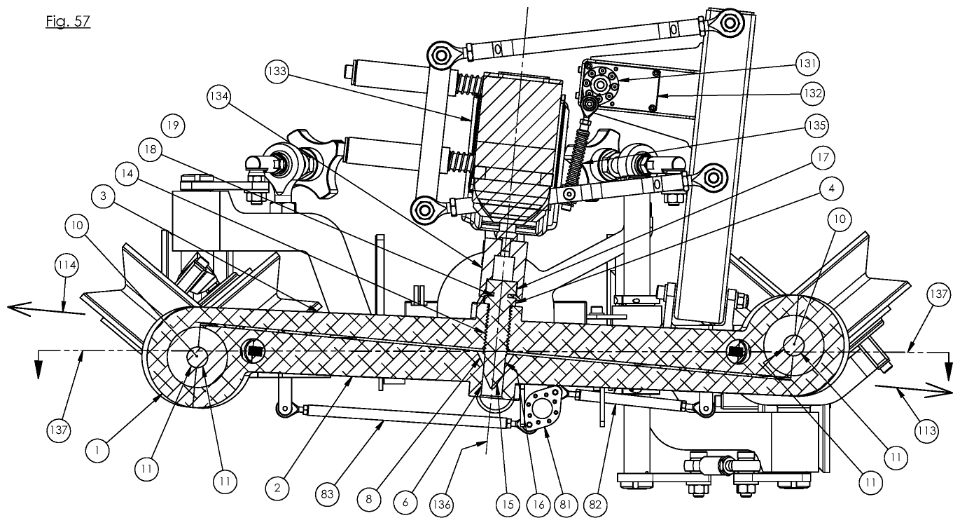

FIG. 55 shows the configuration of robot 19 once the first installation step of the first dual line spacer 1 has been completed. In this configuration, rotary servo-actuator 80 (not shown for clarity) has rotated crank arm 81 in the direction shown by arrow 117, moving lower body 2 of dual line spacer 1 in the direction indicated by arrow 114 and moving upper body 3 of dual line spacer 1 in the direction indicated by arrow 114. In this configuration, wires 10 are located within and substantially centered about the gap that exists between concave surfaces 11 of wire retaining blocks 5.

FIG. 56 shows the configuration of robot 19 once the second installation step of the first dual line spacer 1 has been completed. Crank arm 131, which is connected to the output shaft of rotary servo-actuator 132, can be positioned such that impact wrench 133 and socket 134 are lowered such that compression spring 135 is compressed, placing downward force on impact wrench 133 and socket 134. In this configuration, socket 134 can mechanically engage upper bolt head 17 of clamping bolt 4 in such a way so that rotation of socket 134 about axis 136 causes clamping bolt 4 to also rotate about axis 136.

FIG. 57 shows the configuration of robot 19 once the third installation step of the first dual line spacer 1 has been completed. In some embodiments, impact wrench 133 can be activated by computer 28 such that socket 134 can be rotated about axis 136 in the direction required to thread clamping bolt 4 into female threaded hole 14 in upper body 3. This motion can continue until clamping bolt 4 is fully inserted and fully seated into female threaded hole 14 in upper body 3 such that further rotation of clamping bolt 4 is not possible, and further application of torque 76 can cause necked down section 18 of clamping bolt 4 to fail. As clamping bolt 4 completes the downward motion, impact wrench 133 and socket 134 matches this downward motion due to the downward force acting upon impact wrench 133 due to the compressive force contained within compression spring 135 which ensures socket 134 remains seated on upper bolt head 17 of clamping bolt 4. As clamping bolt 4 threads into female threaded hole 14 in upper body 3, convex conical end 15 of clamping bolt 4 contacts the interior of concave conical upper surface 8 of the retaining hole 6 that passes through lower body 2, convex conical end 15 of clamping bolt 4 applies substantial force to the interior of concave conical upper surface 8 of the retaining hole 6, forcing clamping bolt 4 and upper body 3 to move in the direction of arrow 113 and lower body 2 to move in the direction of arrow 114. This motion compresses wire retaining blocks 5 as they contact each other with great force, as well as compressing the concave surfaces 11 of wire retaining blocks 5 around the outer diameter of wires 10.

After clamping bolt 4 has been fully threaded into female threaded hole 14 in upper body 3, convex conical end 15 of clamping bolt 4 no longer contacts the interior of concave conical upper surface 8 of the retaining hole 6 that passes through lower body 2. In this configuration, the lower unthreaded cylindrical surface 16 of clamping bolt 4 can now be inserted into the cylindrical inner surface of retaining hole 6, which has caused the axis of clamping bolt 4 to be substantially coaxial with the axis of the cylindrical inner surface of retaining hole 6. Upper body 3 has moved as far as possible in the direction of arrow 133 and lower body 2 has moved as far as possible in the direction of arrow 114 fully compressing wire retaining blocks 5 into each other as well as firmly compressing the concave surfaces 11 of wire retaining blocks 5 around the outer diameter of Wires 10. This can firmly secure dual line spacer 1 to wires 10, preventing further relative movement between dual line spacer 1 and Wires 10. Once this configuration is reached, upper bolt head 17 is further tightened until the torque being transmitted into clamping bolt 4 by being used to tighten clamping bolt 4 is sufficient to cause the necked down section 18 of clamping bolt 4 to fail, causing upper bolt head 17 to break away from the main body of clamping bolt 4.

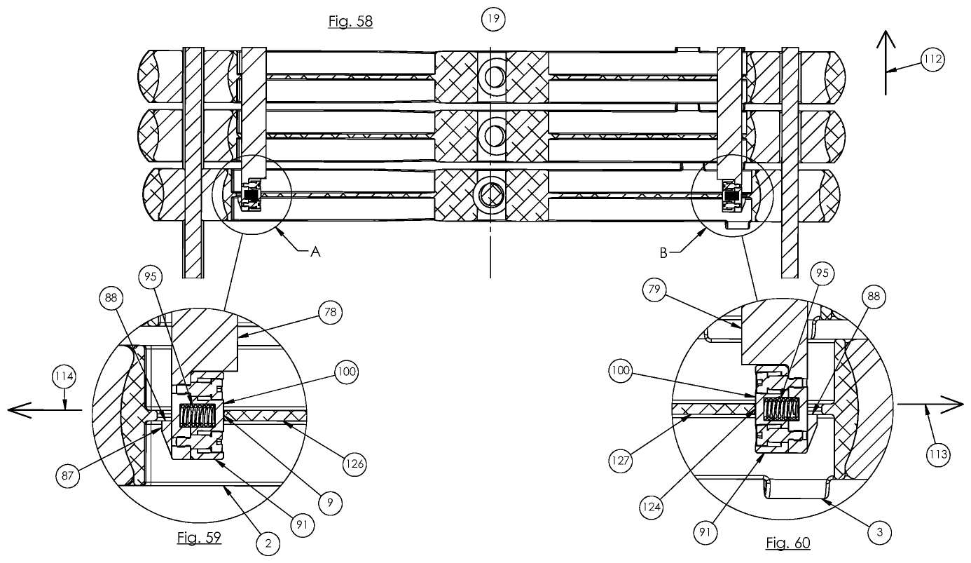

FIG. 58 shows a cropped section view of robot 19, with the section plane shown as line 137 in FIG. 57. FIG. 59 shows a detail view of the end of left hand magazine rod 78. In this view, it can be seen that the outer circumference of hole 9 has pushed against the cylindrical surface 100 of detent block 91 and forced detent block 91 to move in the direction of arrow 114, compressing compression spring 95. This action can result in face 126 of lower body 2 to be no longer trapped behind catch 88, which is a facet of stop catch 87. Thus configured, it can be seen that robot 19 can now be moved in the direction of arrow 112 without face 126 of lower body 2 fouling on catch 88, which is a facet of stop catch 87. Thus, when robot 19 is driven in the direction of arrow 112, dual line spacer 1 can remain where it is with respect to wire 10, and left hand magazine rod 78 can be withdrawn from hole 9 of lower body 2 of first dual line spacer 1. It can be seen that continuation of this motion of robot 19 in the direction of arrow 112 can cause hole 9 to no longer push against the cylindrical surface 100 of detent block 91 as it clears the rearmost end of detent block 91. At this moment, compression spring 95 can force detent block 91 of left hand magazine rod 78 to move back into its resting position in the direction of arrow 114.

FIG. 60 shows a detail view of the end of right hand magazine rod 79. In this view, it can be seen that the outer circumference of hole 124 has pushed against the cylindrical surface 100 of detent block 91 and forced detent block 91 to move in the direction of arrow 113. This action results in face 127 of upper body 3 to be no longer trapped behind catch 88 which is a facet of Stop Catch 87. Thus configured, it can be seen that robot 19 can now be moved in the direction of arrow 112 without face 127 of lower body 2 fouling on catch 88 which is a facet of stop catch 87. Thus, when robot 19 is driven in the direction of arrow 112, dual line spacer 1 can remain where it is with respect to wire 10 and right hand magazine rod 79 can be withdrawn from hole 124 of upper body 3 of first dual line spacer 1. It can be seen that continuation of this motion of robot 19 in the direction of arrow 112 will cause hole 124 to no longer push against the cylindrical surface 100 of detent block 91 as it clears the rearmost end of detent block 91. At this moment, compression spring 95 can force detent block 91 of right hand magazine rod 79 to move back into its resting position in the direction of arrow 113.

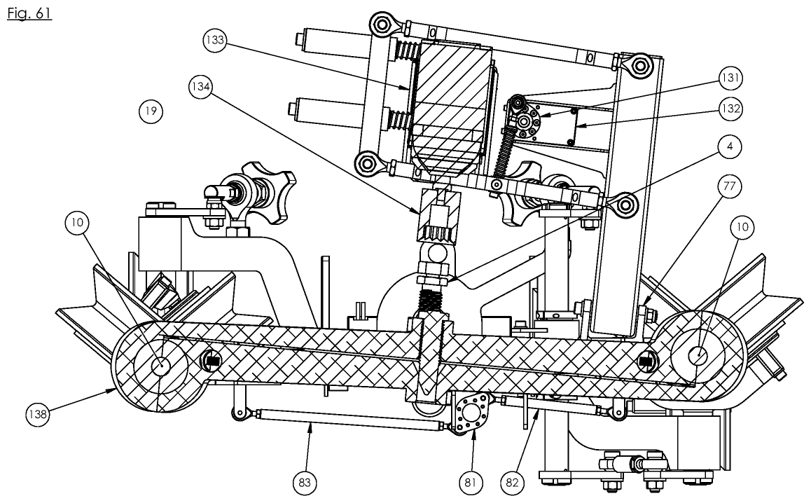

FIG. 61 shows the configuration of robot 19 once the fourth installation step of the first dual line spacer 1 has been completed. Crank arm 131, which is connected to the output shaft of rotary servo-actuator 132, can be positioned such that impact wrench 133 and socket 134 are raised such that socket 134 will not foul on clamping bolt 4 of second dual line spacer 138, which is the next dual line spacer in the installation sequence as it moves backwards with respect to robot 19 as robot 19 is driven forwards. FIG. 61 also shows how upper bolt head 17 has broken away from the main body of clamping bolt 4. Generally, upper bolt head 17 can be allowed to fall to earth after the force of gravity causes it to become disengaged with socket 134.

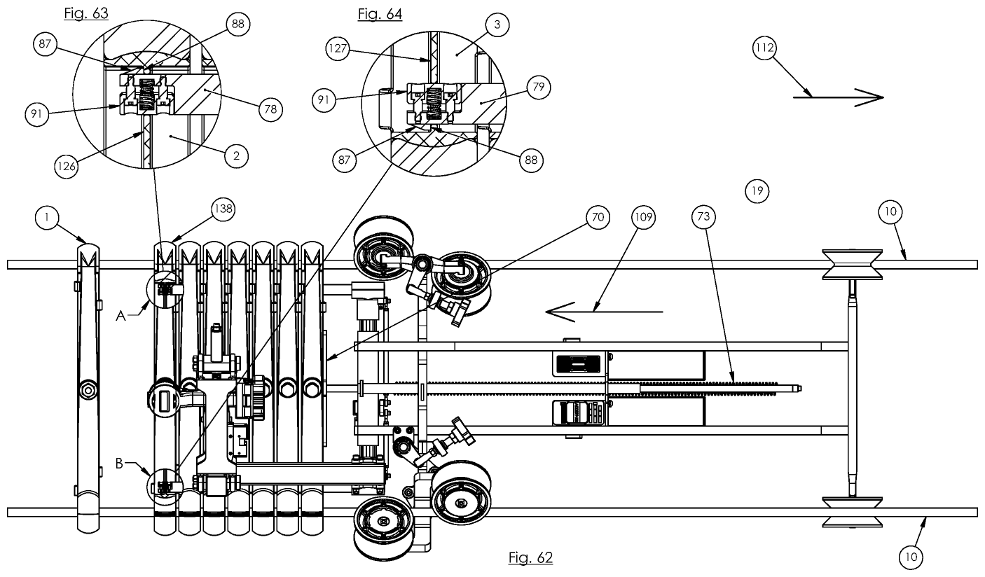

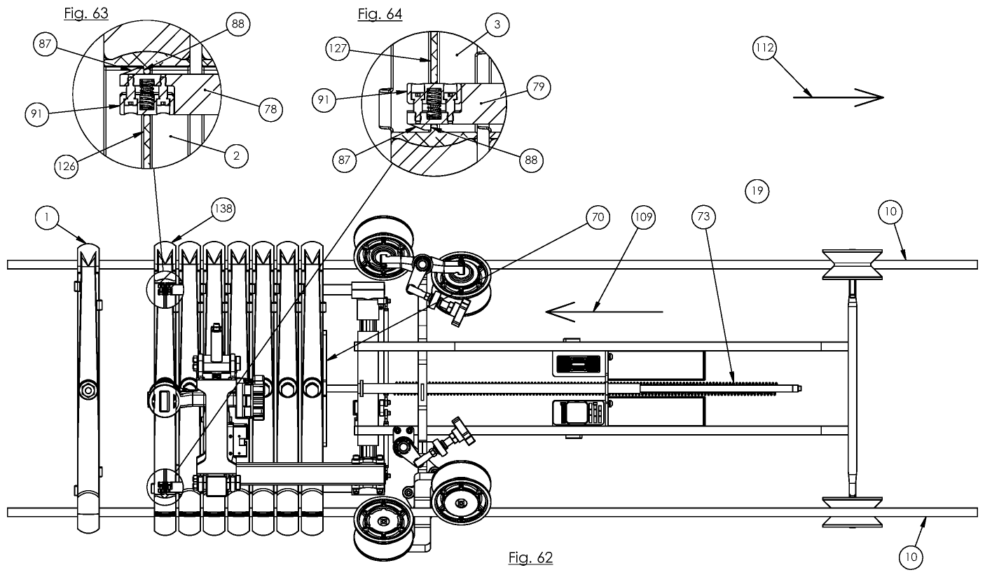

FIG. 62 shows a top view of robot 19 after it has driven in the direction of arrow 112 a distance that is sufficient for first dual line spacer 1, which is now installed on wires 10, to clear the installation mechanism of robot 19. Due to the tension force stored in spring 73, pusher 70 has pushed the remaining plurality of dual line spacers 1 in the direction of arrow 109 until face 126 of lower body 2 of second dual line spacer 138 has come to rest against catch 88, which is a facet of stop catch 87 of left hand magazine rod 78, as seen in FIG. 63, and as shown in FIG. 61. In addition, face 127 of upper body 3 of second dual line spacer 138 has come to rest against catch 88, which is a facet of stop catch 87 of right hand magazine rod 79, as seen in FIG. 64, and as shown in FIG. 62.

The final installation step involves reconfiguring robot 19 in the way shown in FIG. 54 such that more clearance exists between wire retaining blocks 5 of the remaining plurality of dual line spacers 1 and wires 10. Thus configured, robot 19 can quickly move along wires 10 to the next installation position. This sequence of events can be repeated until there are no longer any dual line spacers 1 left in the magazine of robot 19. Once this has occurred, robot 19 can be manually removed from wires 10 and lowered to the ground with a crane or bucket truck, where it can be reloaded with another plurality of dual line spacers 1 and the entire process can be repeated.

It can be seen in FIG. 54 that bolt tightening assembly 26 can be attached to right hand rod carrier 77 such that socket 134 is at all times oriented substantially coaxially with clamping bolt 4 of the dual line spacer 1 located at the rear of magazine assembly 25, such that downward movement of impact wrench 133 always results in engagement of clamping bolt 4 of the dual line spacer 1 located at the rear of magazine assembly 25 into the inner surface of socket 134.

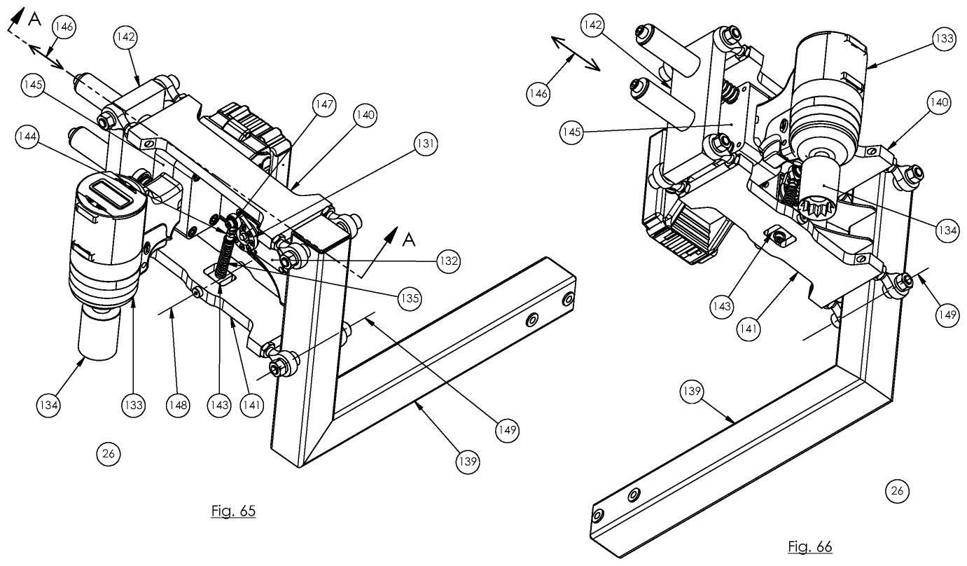

FIG. 65 shows an upper perspective view of bolt tightening assembly 26, and FIG. 66 shows a lower perspective view of bolt tightening assembly 26. In some embodiments, bolt tightening assembly 26 can comprise of support arm 139, upper parallelogram arm 140, lower parallelogram arm 141, upright 142, rotary servo-actuator 132, crank arm 131, pivot block 143, pushrod 144, impact wrench 133, and wrench holder 145.

In some embodiments, the purpose of bolt tightening assembly 26 is to control the position and orientation of impact wrench 133 and socket 134 such that it can be used to tighten clamping bolt 4 of dual line spacers 1 when required. In some embodiments, socket 134 can be coupled to the rotary output shaft of impact wrench 133 in such a way as to transmit rotary motion from impact wrench 133 into socket 134. In some embodiments, impact wrench 133 can be any suitably configured handheld rotary driver that has the ability to develop sufficient torque, for example, the M18 FUEL™ ¼″ Hex Impact Driver manufactured by Milwaukee Electric Tool Corporation of Brookfield, Wisconsin. In some embodiments, impact wrench 133 can be securely mounted to wrench holder 145, which can be secured to upright 142 in such a way as to allow no relative movement between wrench holder 145 and upright 142 except movement in the direction indicated by arrow 146. This movement is required to enable impact wrench 133 and socket 134 to remain aligned with clamping bolt 4 when socket 134 is engaged with clamping bolt 4 because upright 142 sweeps through an arcing motion rather than a purely vertical motion as it is moved up and down by rotary servo-actuator 132 acting on the parallelogram mechanism formed by support arm 139, upper parallelogram arm 140, lower parallelogram arm 141 and upright 142. To facilitate motion of this parallelogram mechanism, both ends of upper parallelogram arm 140 and lower parallelogram arm 141 can be fitted with a plurality of rotary bearings, in this case, Heim Joints, but it will be known to those skilled in the art that other types of rotary bearings can be used.

In some embodiments, rotary servo-actuator 132 can be fastened to support arm 139. The rotary output shaft of rotary servo-actuator 132 can be fitted with crank arm 131, which can be connected to the upper end of pushrod 144 through Heim joint 147 at a position substantially radially offset from the axis of rotation of the rotary output shaft of rotary servo-actuator 132. In some embodiments, pushrod 144 can pass through a hole that passes through pivot block 143, which can be rotatably connected to lower parallelogram arm 141 such that pivot block 143 can rotate with respect to lower parallelogram arm 141 about axis 148. Thus configured, it can be seen that rotation of the rotary output shaft of rotary servo-actuator 132 can cause lower parallelogram arm 141 to pivot about axis 149, which can cause upright 142, wrench holder 145, impact wrench 133 and socket 134 to raise and lower as required.

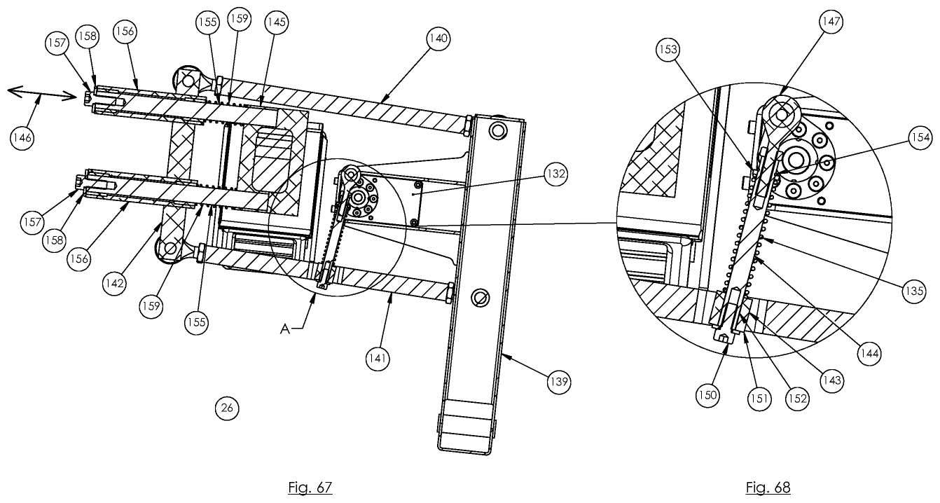

FIG. 67 shows a sectioned view of bolt tightening assembly 26 through a vertical plane. FIG. 68 shows a detailed view of FIG. 67 detailing the mechanism that raises and lowers impact wrench 133. It can be seen that the lower end of pushrod 144 can be fitted with bolt 150 and washer 151 such that tension force on pushrod 144 can be transmitted into pivot block 143. In some embodiments, pushrod 144 can slide downwards through hole 152 in pivot block 143, thus the only compressive force that can be transmitted from pushrod 144 into pivot block 143 is that provided by the compression of compression spring 135, which can be fitted over pushrod 144. The upper end of compression spring 135 can be secured to pushrod 144 by pressing on washer 153, which can be prevented from moving upwards with respect to pushrod 144 by snap ring 154, which can be fitted to a circumferential groove in pushrod 144. The lower end of compression spring 135 can push against the upper surface of pivot block 143. Thus configured, when raising lower parallelogram arm 141, servo-actuator 132 can directly act on lower parallelogram arm 141 through bolt 150 and washer 151, but when lowering lower parallelogram arm 141, servo-actuator 132 can indirectly act on parallelogram arm 141 through compression spring 135. Thus, compression spring 135 can limit the amount of downward force that can be imparted on lower parallelogram arm 141 thus preventing damage to rotary servo-actuator 132 through overload.

To facilitate side to side movement by wrench holder 145 with respect to upright 142 in the direction of arrow 146 as impact wrench 133 and socket 134 tightens clamping clamping bolt 4 of a line spacer, wrench holder 145 can be fitted with a plurality of slide rods 155 that can slide within tubes 156 in the direction of arrow 146. Travel to the right can be limited by bolts 157 and washers 158, while travel to the left can be resisted by the compression of compression springs 159 that are fitted over slide rods 155. Thus configured, wrench holder 145 can move with respect to upright 142 in the direction of arrow 146 such that socket 134 can remain aligned with clamping bolt 4 during the tightening process. In some embodiments, compression springs 159 can ensure that, in the resting state, wrench holder 145 can always be pushed as far as possible to the right, providing consistent and repeatable engagement of socket 134 with clamping bolt 4.

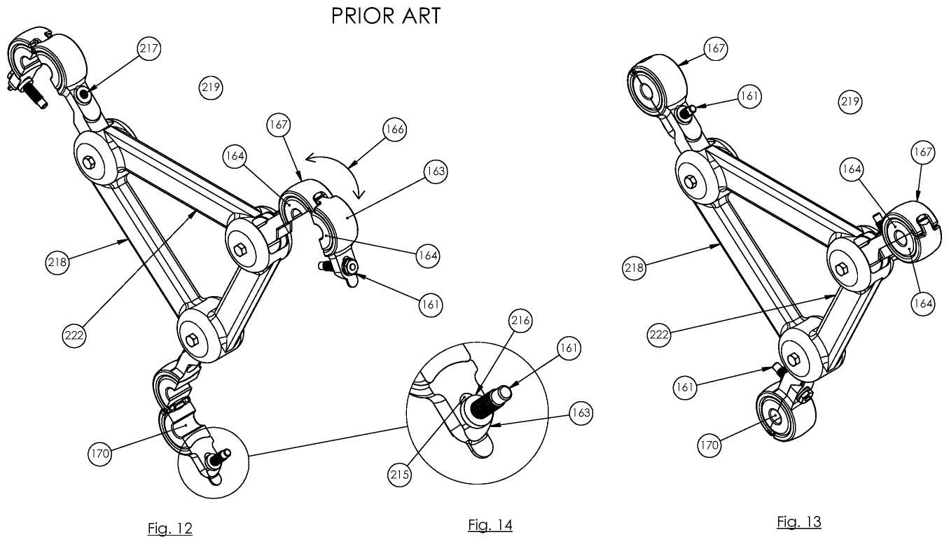

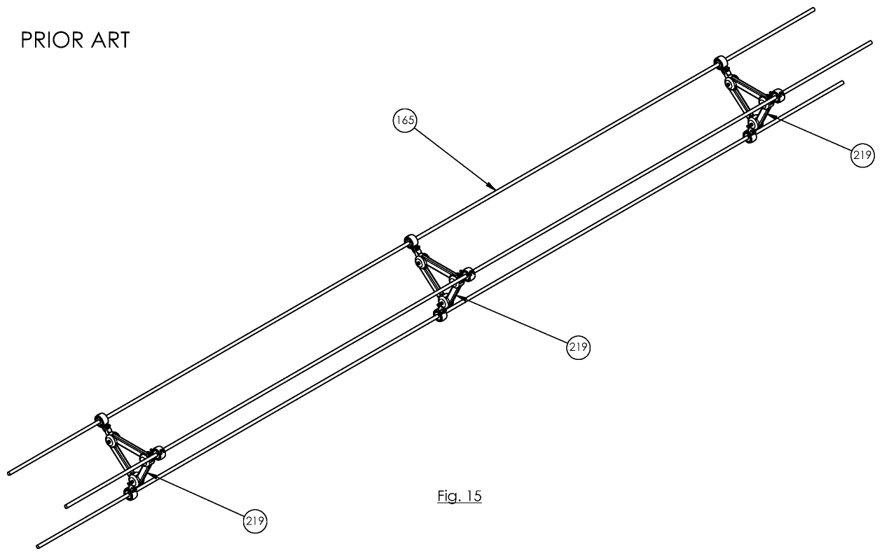

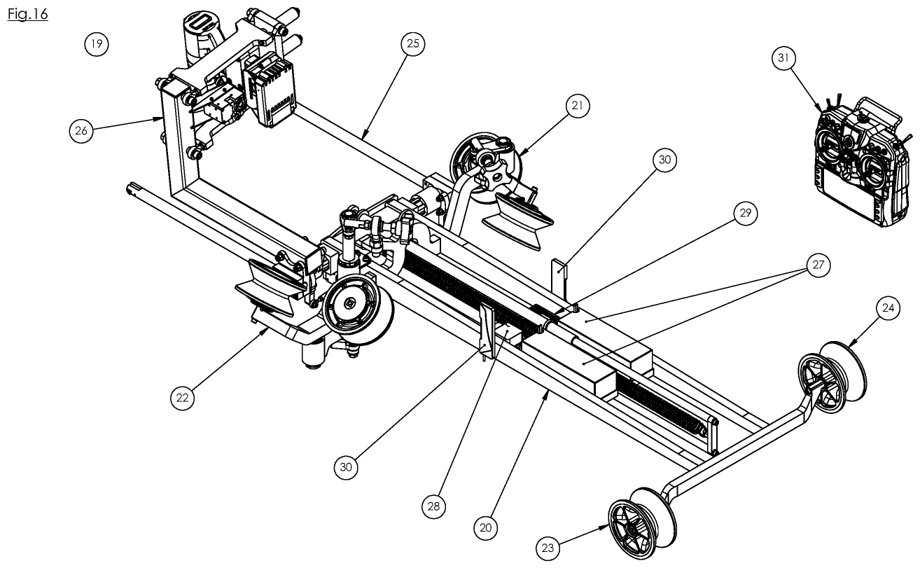

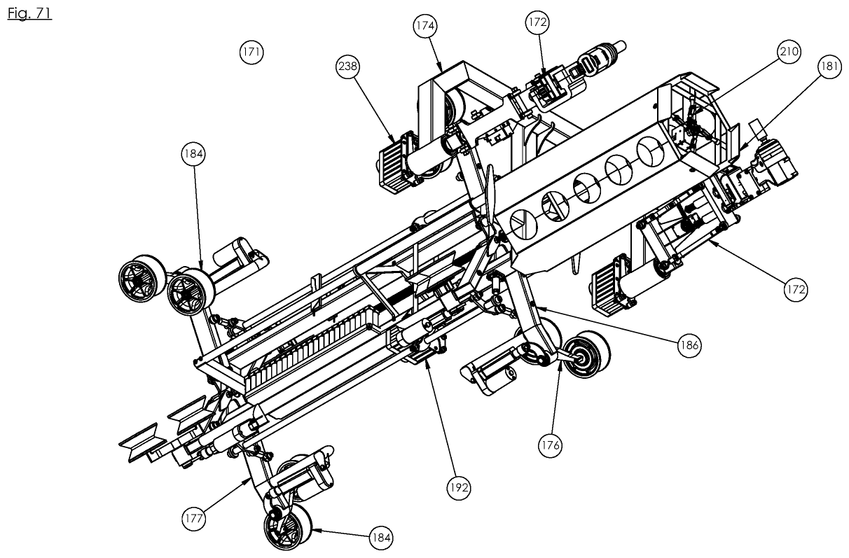

FIG. 70 shows a forward upper perspective view, and FIG. 71 shows a rear lower perspective view of robot 171 that can automatically install a plurality of quad line spacers 160 to each conductor group of the power line, substantially equally spaced at a predetermined interval along each span, as depicted in FIG. 11. In some embodiments, robot 171 can comprise of frame 174, four left hand bogey support arms 177, four right hand bogey support arms 186, four driven wheel bogey assemblies 176, four idler wheel bogey assemblies 188, magazine assembly 181, two installation arm assemblies 172, spring loaded pusher assembly 175, one or more batteries 178, computer 28, radio modem 29, antennas 30, and ground station 31. In some embodiments, the four driven wheel bogey assemblies 176 can be fitted with a plurality of wheels that contain internal electric motors that can be powered by batteries 178 that can allow robot 171 to drive along wires as commanded by the computer 28. To operate robot 171, the human operator can use ground station 31 to send radio signals to one or more antennas 30, which are connected to radio modem 29. In some embodiments, radio modem 29 can decode the radio signals from ground station 31, and can send these signals to computer 28 that, in turn, can send signals to the electrical equipment fitted to robot 171, for example, one or more of the electrically driven wheels, the rotary servo-actuators and the linear actuators, to cause robot 171 to complete its task of installing a plurality of quad line spacers 160 onto wires 165. The computer can, in some embodiments, be programmed to operate robot 171 automatically without operator input or semi-automatically by taking cues from the human operator via the ground station 31 as desired.

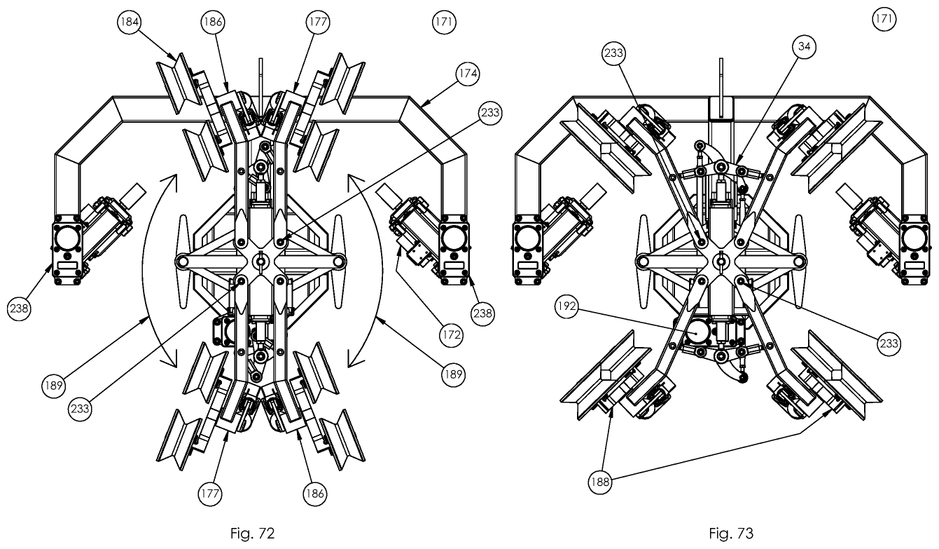

FIG. 72 shows a front view depicting the mounting configuration of robot 171, and FIG. 73 shows a front view depicting the installation configuration of the left bogey support arms 177 and right bogey support arms 186. This mounting configuration can permit the passage of robot 171 between the wires 165. In order to mount robot 171 onto the wires 165 using the wheel bogey assemblies 176 and 188, left hand bogey support arms 177 and right hand bogey support arms 186 can be connected to frame 174 via hinges 233 that allow them to pivot about frame 174 in a manner indicated by arrows 189. The rotary output shaft of arm servo motor 192 can be connected to left hand bogey support arms 177 and to right hand bogey support arms 186 through a system of shafts, levers and linkages in such a manner as to allow rotation of the output shaft of arm servo motor 192, as commanded by the human operator via the transmitter 31, to cause rotation of left hand bogey support arms 177 and right hand bogey support arms 186 about their respective hinges 233 in the manner indicated by arrows 189. This can allow the human operator to command robot 171 to change configuration from that depicted in FIG. 72 to that depicted by FIG. 73 and back again as required during the process of installing robot 171 onto the plurality of wires 165 prior and uninstalling robot 171 from the plurality of wires 165.

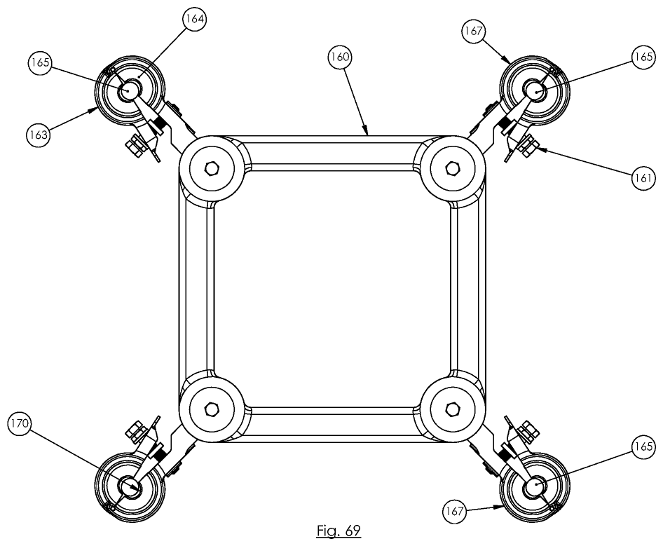

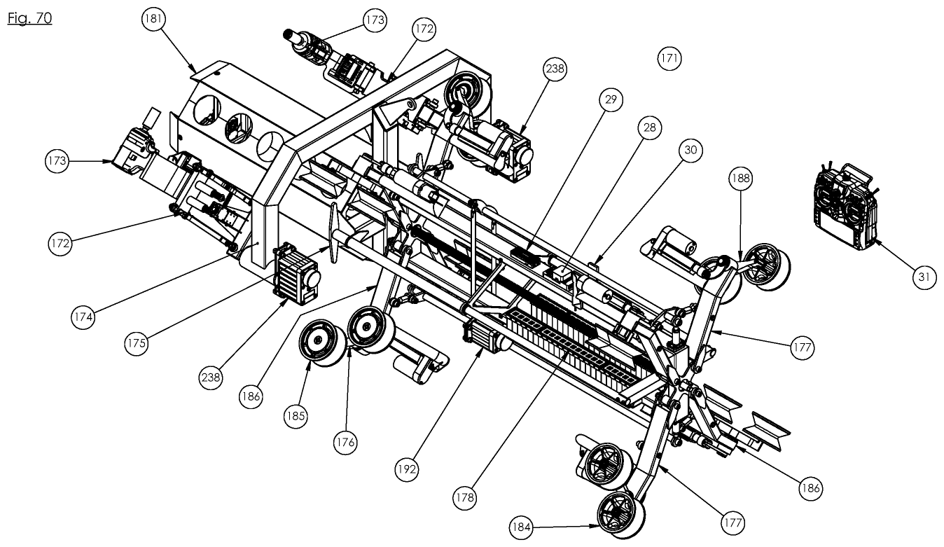

FIG. 69 shows a depiction of quad line spacer 160 after loose installation onto four wires 165. In this configuration, it can be seen that the wires 165 are captivated by the wire retaining blocks 164 but the quad line spacer 160 is still free to move axially along the Four wires 165.

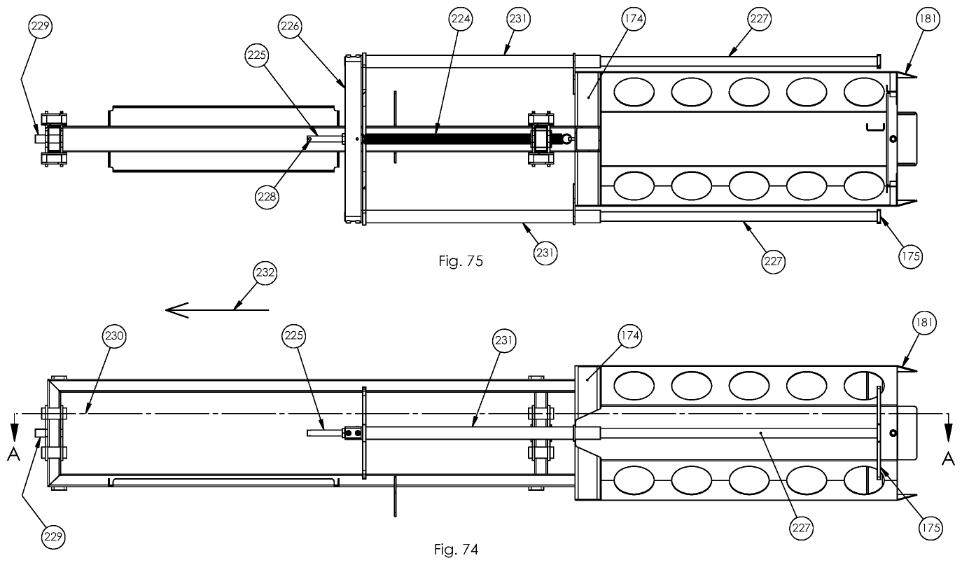

FIG. 74 depicts the process of mounting robot 171 onto the plurality of wires 165. Prior to installing robot 171, the human operator must install the number of quad line spacers 160 desired to be installed on the plurality of wires 165 at a position substantially clear of the location of which the robot 171 will be mounted upon the wires 165. The quad line spacers 160 must be installed in the manner depicted in FIG. 69, in which clamping bolts 161 are only partially threaded into threaded holes 217 of clamping arms 167, securing the plurality of quad line spacers 160 to the plurality of wires 165 but allowing them to freely slide axially along the plurality of wires 165.

Before lifting robot 171 into position, spring loaded pusher assembly 175 must be cocked and locked into position. The purpose of the spring loaded pusher assembly 175 is to push the plurality of quad line spacers 160 towards the end of magazine assembly 181 as robot 171 installs the plurality of quad line spacers 160 on wires 165. Cocking the pusher assembly 175 is necessary to input the energy required to complete this task, and locking it is necessary to hold the cocked pusher assembly 175 in the cocked position until robot 171 has been installed on wires 165 and the plurality of quad line spacers 160 have been installed onto magazine assembly 181.

FIG. 74 shows a side view of partial frame 174, pusher assembly 175 and tension spring 224 prior to the cocking procedure. FIG. 75 shows a section view of FIG. 74, sectioned through section line 230. In some embodiments, pusher assembly 175 can comprise of a plurality of pusher rods 227, pusher crossmember 226 and spigot 225. The plurality of pusher rods 227 can be fitted into, and are free to slide inside, a plurality of frame tubes 231 which can be an integral part of frame 174. The plurality of pusher rods 227 can be connected together via pusher crossmember 226. In some embodiments, spigot 225 can be connected to pusher crossmember 226 and can be substantially axially aligned with spigot tube 229, which can be an integral part of frame 174. In some embodiments, spigot 225 can be sized such that it can easily pass through the internal bore of spigot tube 229 as pusher assembly 175 moves in the direction of arrow 232. In some embodiments, tension spring 224 can be fitted such that one end can connects to pusher crossmember 226 and the other end can connect to frame 174, and can be preloaded to provide tension force to pusher assembly 175 throughout the full range of travel of pusher assembly 175 as it slides inside frame tubes 231 during the operation of robot 171.

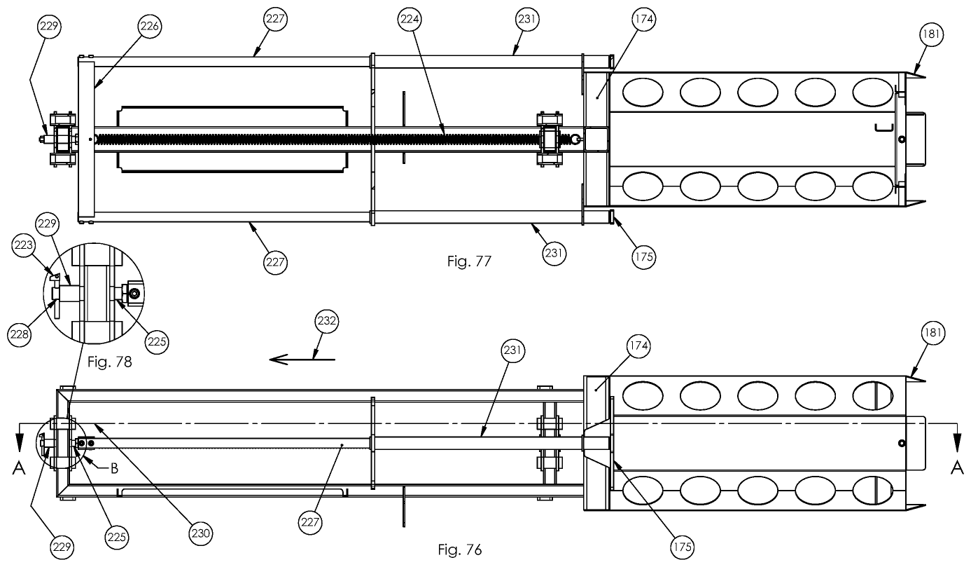

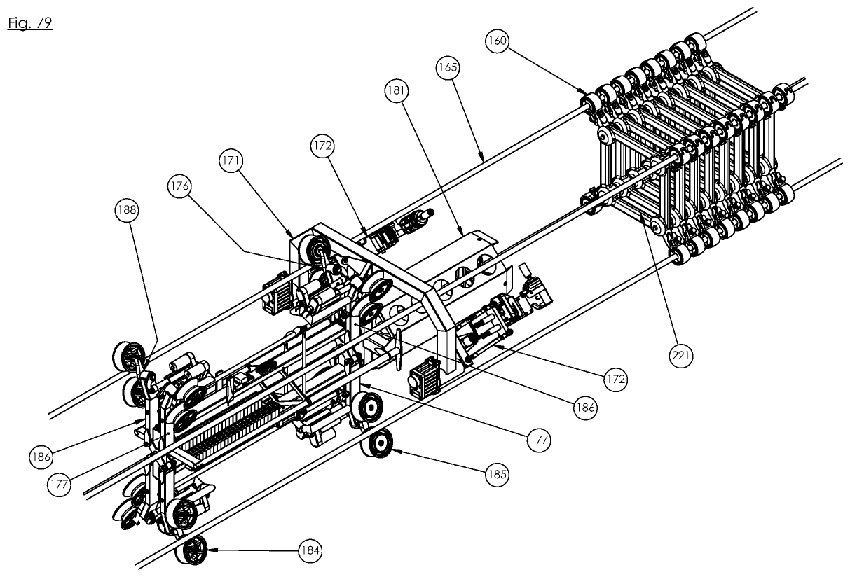

FIG. 76 shows a side view of partial frame 174, pusher assembly 175 and tension spring 224 after the cocking procedure has been completed. FIG. 77 shows a section view of FIG. 76, sectioned through section line 230. FIG. 78 shows a detail view of FIG. 76, showing spigot 225 fully inserted into spigot tube 229 with locking pin 223 installed into spigot hole 228. To cock the pusher assembly 175, pusher assembly 175 can be manually moved against the force of tension spring 224 with respect to frame 174 in the direction indicated by arrow 262 until spigot 225 fully protrudes through spigot tube 229 such that spigot hole 228, which passes radially through the end of spigot 225, is accessible such that locking pin 223 can be inserted into spigot hole 228. Thus configured, releasing the force required to cock the pusher assembly 175 can cause locking pin 223 to contact the outer extremity of spigot tube 229 and prevent any further motion of pusher assembly 175 in the direction opposite of arrow 232.

Once the plurality of quad line spacers 160 have been partially installed on wires 165 in the manner depicted in FIG. 79, robot 171 can be lowered between the wires 165 with the left bogey support arms 177 and right bogey support arms 186 positioned as shown in FIG. 72 such that they are substantially clear of the wires 165. Once the robot 171 is positioned within the wires 165, left bogey support arms 177 and right bogey support arms 186 can be commanded to spread apart along arrow 189 to align the wires 165 substantially within the driven wheel bogey assemblies 176 and idler wheel bogey assemblies 188. When the wires 165 are substantially aligned within the wheel bogey assemblies 176 and 188, the wheel bogey assemblies 176 and 188 can be commanded to rotate to confine the wires 165 between the grooves of the driven wheels 185 and idler wheels 184.

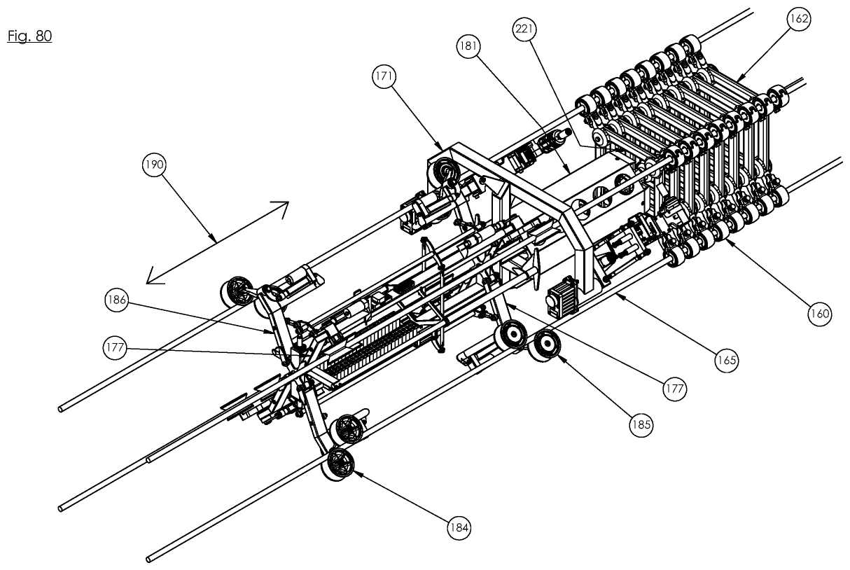

FIG. 80 depicts the robot 171 once the left bogey support arms 177 and right bogey support arms 186 have been fully spread, and the driven wheel bogey assemblies 176 and idler wheel bogey assemblies 188 have been rotated to substantially captivate the wires 165. When this process is complete, the robot 171 can supported by, and free to drive along, wires 165 in the direction shown by arrow 190. The human operator can then command robot 171 to drive towards the plurality of quad line spacers 160 in the direction of arrow 190. This causes the magazine assembly 181 of robot 171 to slide into the square holes 221 that perforate the main body 162 of quad line spacers 160. This is possible because the external shape of the magazine assembly 181 of robot 171 can closely match the internal shape of the square holes 221 of quad line spacers 160. When the magazine assembly is fully inserted into the main bodies 162 of the plurality of quad line spacers 160, referring to FIGS. 94, 95 and 96, the retention pin assembly 210 can be commanded to extend the retention pins 202, which can captivate the quad line spacers onto magazine assembly 181. When the retention pins 202 are in place, referring to FIGS. 76, 77 and 78, locking pin 223 can be manually removed from the spigot hole 228 in spigot 225, releasing the pusher assembly 175 and allowing pusher assembly 175 to apply force to the quad line spacers 160 in the magazine assembly 181 due to the tension force in stretched tension spring 224, ensuring quad line spacers 160 are fully seated against retention pins 202.

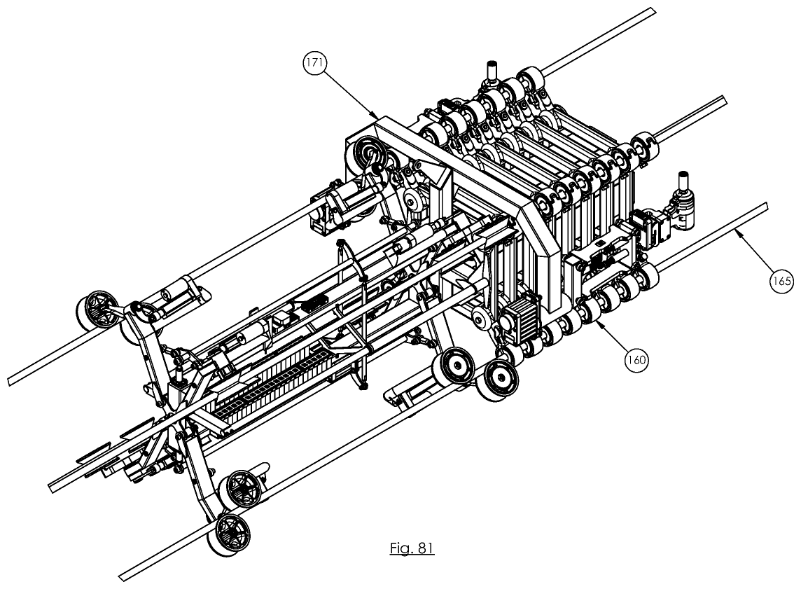

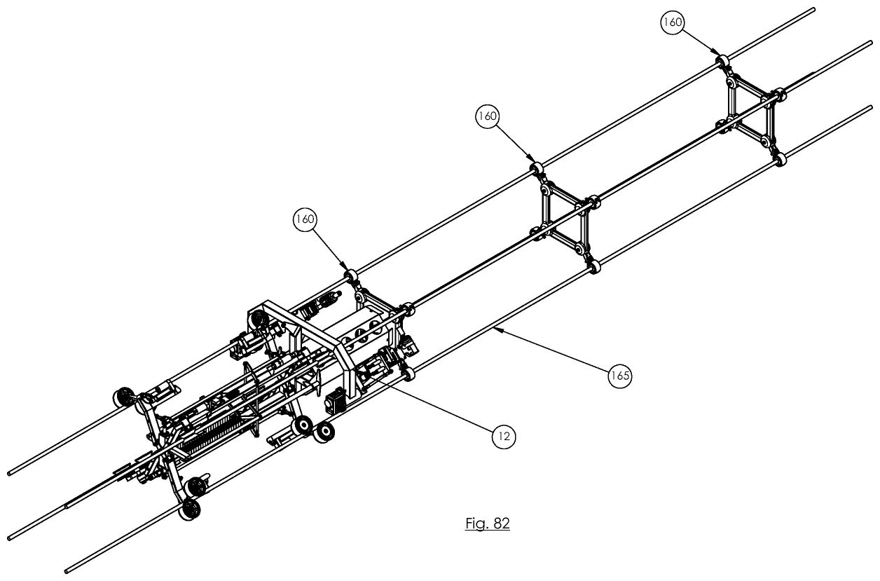

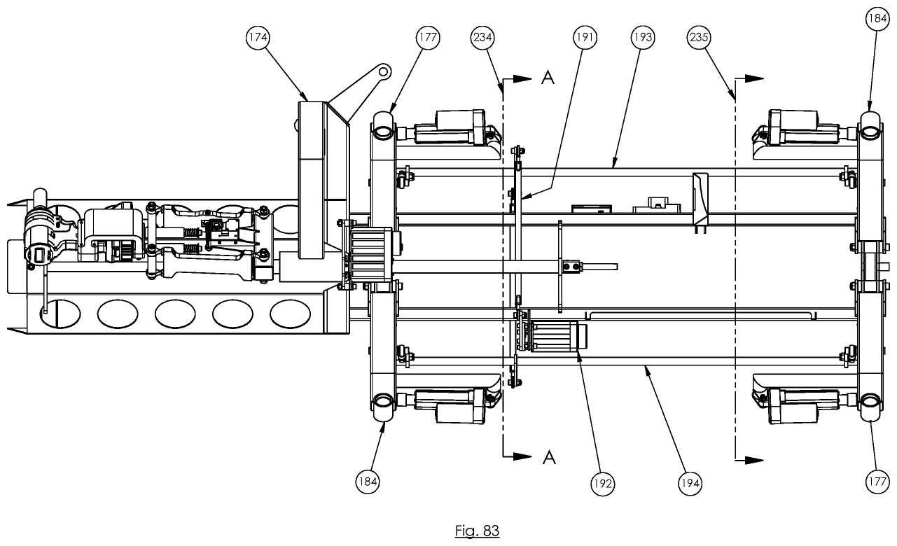

FIG. 81 shows robot 171 fully loaded with quad line spacers 160 and prepared to begin installation. The human operator can now command the robot 171 to drive along the line and command installations of quad line spacers 160 at a plurality of predetermined locations along the wires 165 as shown in FIG. 82.

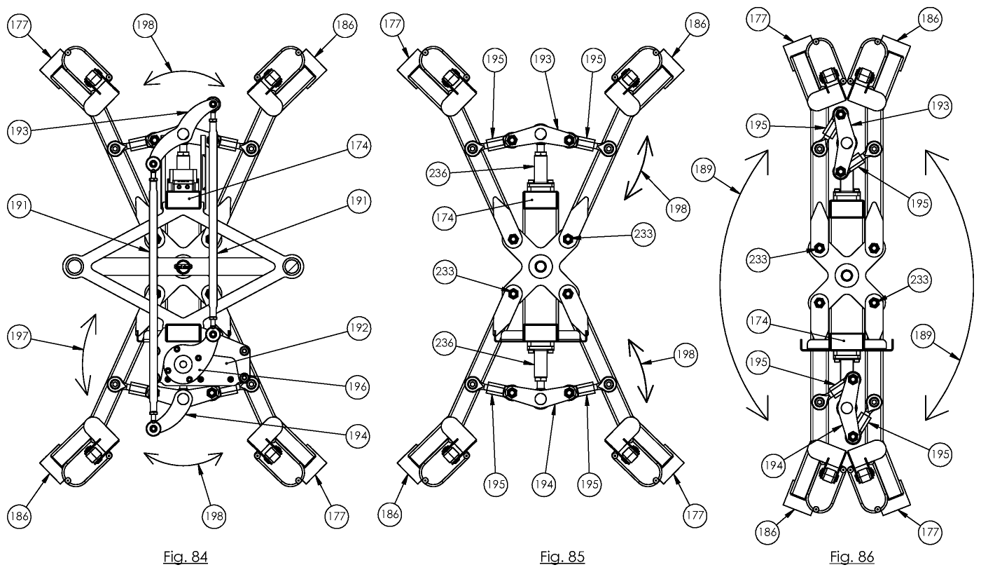

FIG. 83 depicts a side view of robot 171. FIG. 84 depicts a section view of FIG. 83 through line 234 and shows the mechanism which moves the left bogey support arms 177 and right bogey support arms 186 in unison. FIG. 85 depicts a section view of FIG. 83 through line 235 and shows the left bogey support arms 177 and right bogey support arms 186 in the extended configuration. FIG. 85 depicts a section view of FIG. 83 through line 235 and shows the left bogey support arms 177 and right bogey support arms 186 in the retracted configuration. The mechanism shown in FIG. 85 and FIG. 86 is duplicated situated at the opposing end of robot 171 to provide positional control over the second group of two left bogey support arms 177 and two right bogey support arms 186 that are not shown in FIG. 85 and FIG. 86.

Referring to FIG. 84, first arm linkage 191 can transmit commanded rotational motion about arrow 197 from the arm servo motor 192 through the servo horn 196 to the top pivot arm 193 and bottom pivot arm 194. The outer extremities of top pivot arm 193 and bottom pivot arm 194 can be rotatably connected to the robot frame 174 using bearing blocks 236, as well known by those skilled in the art. The top pivot arm 193 and bottom pivot arm 194 can be connected to left bogey support arms 177 and right bogey support arms 186 with linkages 195 that can translate the rotation about arrow 198 of the top pivot arm 193 and rotation about arrow 198 of the bottom pivot arm 194 into rotation of the left bogey support arms 177 and right bogey support arms 186 about hinges 233 as depicted by arrows 189 in FIG. 86. This can allow left bogey support arms 177 and right bogey support arms 186 to be positioned as desired by computer 28 for clearance between the wires 165 and installation.

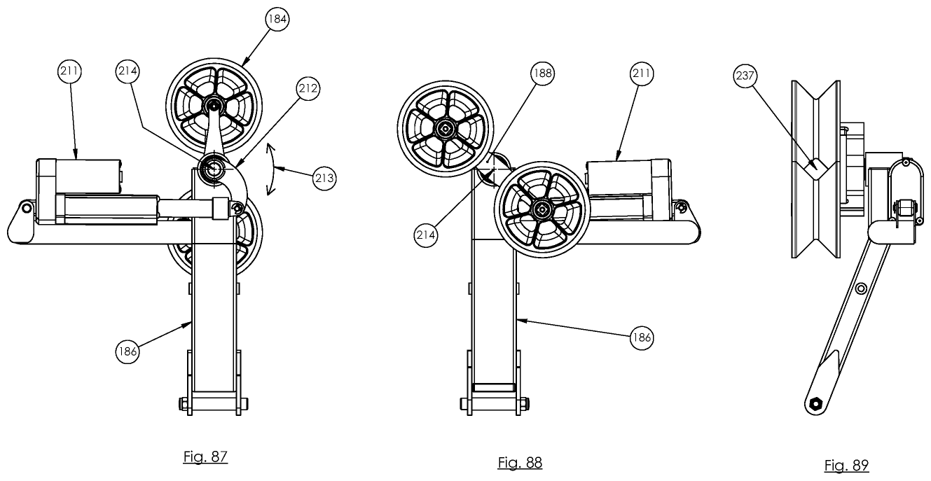

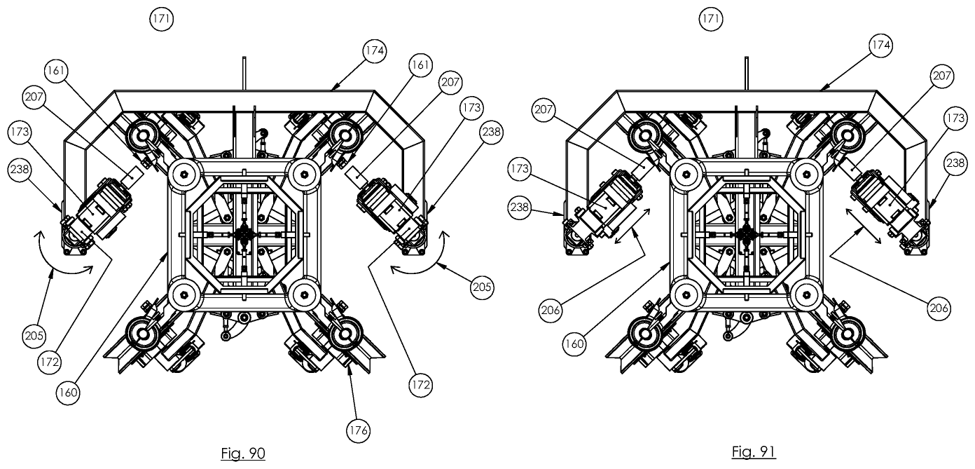

FIG. 87 depicts one of the idler wheel bogey assemblies 188 in the open position, which can allow clearance for the wire 165 to pass though. In this depiction, idler wheel bogey assembly 188 can be rotatably connected to right bogey support arm 186 through pivot axis 214. The angular position of the idler wheel bogey assembly 188 can be controlled by the wheel actuator 211 through the wheel pivot arm 212 that can convert linear displacement of wheel actuator 211 into rotation of idler wheel bogey assembly 188 about pivot axis 214. This can be made possible by one end of wheel actuator 211 being connected to the extremity of wheel pivot arm 214, and the other end of wheel actuator 211 being connected to right bogey support arm 186. This angular displacement is shown by arrow 213. In some embodiments, wheel actuator 211 can comprise any suitable linear actuator as well known by those skilled in the art, such as an electrically driven linear actuator or a pneumatic cylinder. FIG. 88 shows the wheel bogey 188 in the locked configuration, which captivates the wire 165 between the grooves of idler wheels 184 and driven wheels 185. FIG. 89 shows a side view of FIG. 88 showing the gap 237 that the wire 165 is trapped within when the robot 171 is secured to wires 165. In some embodiments, the general arm assembly shown in FIGS. 87, 88 and 89 can be repeated with different combinations of left bogey support arms 177 and right bogey support arms 186 and driven wheel bogey assemblies 176 and idler wheel bogey assemblies 188 to make up the plurality of arm assemblies required to construct robot 171.

FIG. 90 depicts a rear view of the robot 171 in pre installation configuration. In some embodiments, the left and right installation arm assemblies 172 can be rotatably connected to frame 174 via bearing supports that permit rotational motion about the arrows 205 shown. The rotational motion of each installation arm assembly 172 about arrows 205 can be controlled by an arm servo actuator 238. Each output shaft of each arm servo actuators 238 can be rotationally connected to one of the installation arm assembly 172 such that rotational motion of the output shaft of the arm servo actuator 238 can cause rotation of the connected installation arm assembly 172 about arrow 205. The installation arm assemblies 172 can be rotated into a position such that the plurality of impact wrenches 173, which form part of the installation arm assemblies 172, can be aligned substantially concentrically with two of the partially inserted clamping bolts 161 on the quad line spacer 160. The motion of the installation arms 172 can mirror each other on the left and right side of the machine. In some embodiments, impact wrench 173 can be any suitably configured handheld rotary driver that has the ability to develop sufficient torque, for example, the M18 FUEL™ ¼″ Hex Impact Driver manufactured by Milwaukee Electric Tool Corporation of Brookfield, Wisconsin. The construction and operation of the installation arm assemblies 172 can be functionally identical to the bolt tightening assembly 26 of robot 19, the details of which are shown in FIGS. 65, 66, 67 and 68 and described above herein. Note that the orientation and placement of impact wrench 173 differs between bolt tightening assembly 26 of robot 19 and installation arm assembly 172 of robot 171 but this does not significantly change the nature of the operation of the device.

Once the installation arm assemblies 172 align with a plurality of clamping bolts 161, the installation arm assemblies 172 can be commanded to move the attached impact wrench 173 toward the clamping bolts 161 in the direction depicted in FIG. 91 along arrow 206. The mechanism that achieves this motion is shown in FIGS. 65, 66, 67 and 68 and described in detail above herein. Once the motion of the installation arm assemblies 172 is complete, the impact wrench sockets 207 can be substantially seated upon the clamping bolts 161 to allow the transmission of torque from the impact wrench 173 to the clamping bolts 161 rotating them and compressing the hinged clamp mechanism 163 as impact wrenches 173 are commanded to tighten clamping bolts 161 by computer 28. As the Clamping Bolt is rotated, the installation arms can move the impact wrenches 173 along arrows 206 to maintain sufficient engagement of impact wrench sockets 207 with the heads of clamping bolts 161 while tightening as seen in FIG. 91. The clamping bolt 161 can force the hinged clamp mechanisms 163 to rotate about the hinged connection towards the clamping arms 167 to which the hinged clamp mechanisms 163 are rotatably attached. This can also compress the wire retaining blocks 164 around the wires 165 until specified torque is achieved to break away the specially designed head of clamping bolt 161 head. This process is shown in FIG. 57 and FIG. 61 and described above herein. After this has occurred on both sides of quad line spacer 160, the installation arm assemblies 172 can be commanded to move the attached impact wrench 173 away from the recently tightened clamping bolts 161 in the direction depicted in FIG. 91 along arrow 206.

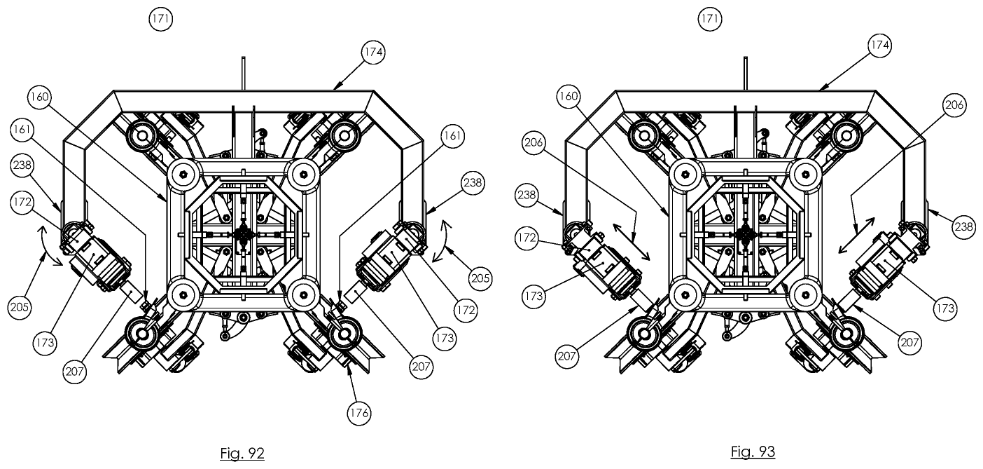

The installation arm assemblies 172 can then be commanded to rotate about arrows 205 to align with the remaining two clamping bolts 161 on quad line spacer 160. This action is depicted in FIG. 92. The process described above is then repeated identically for the remaining clamping bolts 161 as shown in FIG. 93. FIG. 94 depicts a complete installation of the quad line spacer 160 with all the hinged clamp mechanisms 163 installed on the wires 165. Once this has occurred, the newly installed quad line spacer 160 can be released from magazine assembly 181 by retaining pin mechanism 210, and robot 171 can be commanded to move along wires 165 a short distance away from the newly installed quad line spacer 160. The distance moved by the robot 171 is enough to allow the newly installed quad line spacer 160 to clear the magazine assembly 181 but not too much as to allow the next quad line spacer 160 stored in the magazine assembly 181 to clear the magazine assembly 181. Once this motion is complete, retaining pin mechanism 210 can engage to trap the next quad line spacer 160 stored in the magazine assembly 181 to prevent it from falling out of the magazine assembly 181, and robot 171 can then be commanded to move along wires 165 to the next install location where the actions described herein can be repeated to install the next quad line spacer 160 stored in the magazine assembly 181. These actions are repeated until all desired quad line spacers 160 have been installed on wires 165 as depicted in FIG. 82.

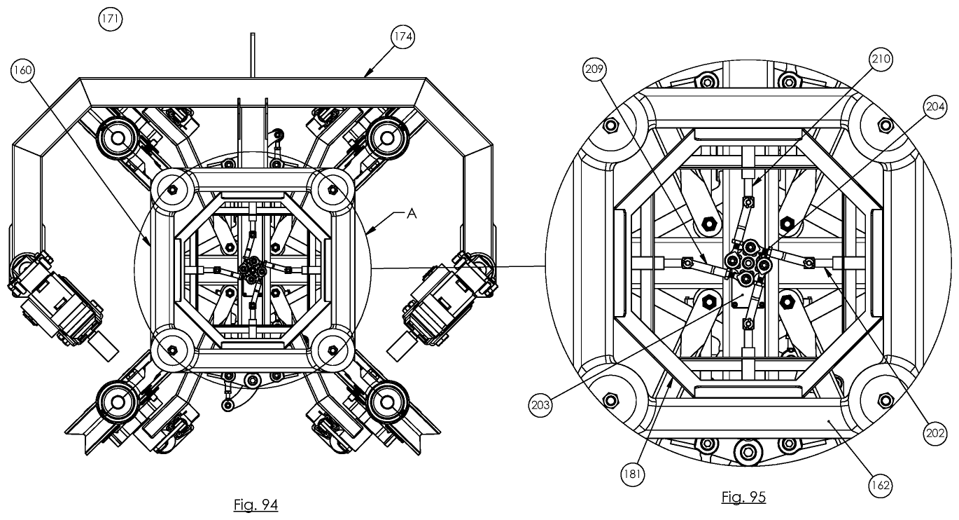

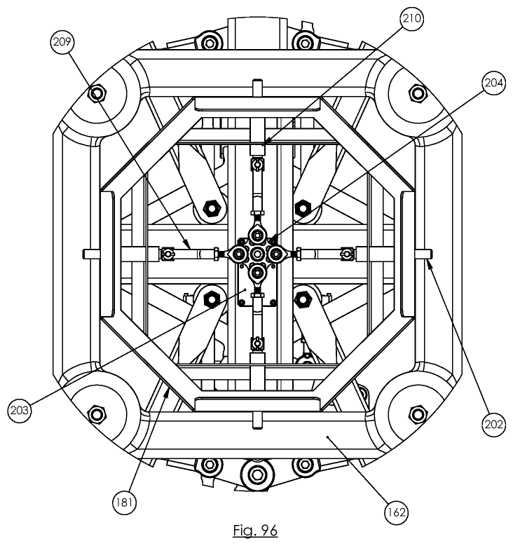

FIG. 95 shows a detailed view of FIG. 94 showing the retaining pin mechanism 210 in the retracted configuration, as used when releasing an installed quad line spacer 160 from magazine assembly 181. FIG. 96 shows the same view as FIG. 95 with retaining pin mechanism 210 in the extended configuration, as used when preventing uninstalled quad line spacers 160 stored in magazine assembly 181 from being mechanism 210 is to contain the one or more quad line spacers 160 within the magazine assembly 181 as well as controlling the release of quad line spacers 160 from magazine assembly 181 after they have been installed. A plurality of retention pins 202 are connected to the central retention pin servo plate 204 by the retention pin linkages 209. The retention pin servo plate 204 is rotationally locked to the output shaft of the retention pin servo 203 such that rotation of the output shaft of the retention pin servo 203 directly rotates the retention pin servo plate 204. The linkage mechanism is designed such that commanded rotation of the retention pin servo plate 204 translates the plurality of retention pins 202 from their fully extended positions shown in FIG. 96 to their retracted positions shown in FIG. 95 allowing for controlled release of installed quad line spacer 160 once the installation is complete. This can occur because in the extended configuration, the main body 162 of the rearmost quad line spacer 160 within the magazine assembly 181 physically contacts the extended ends of retention pins 202, preventing quad line spacers 160 from moving past the end of magazine assembly 181. When the retention pins 202 are retracted by commanded rotation of the retention pin servo plate 204, this contact no longer occurs and the installed quad line spacers 160 is able to physically move past the end of magazine assembly 181.

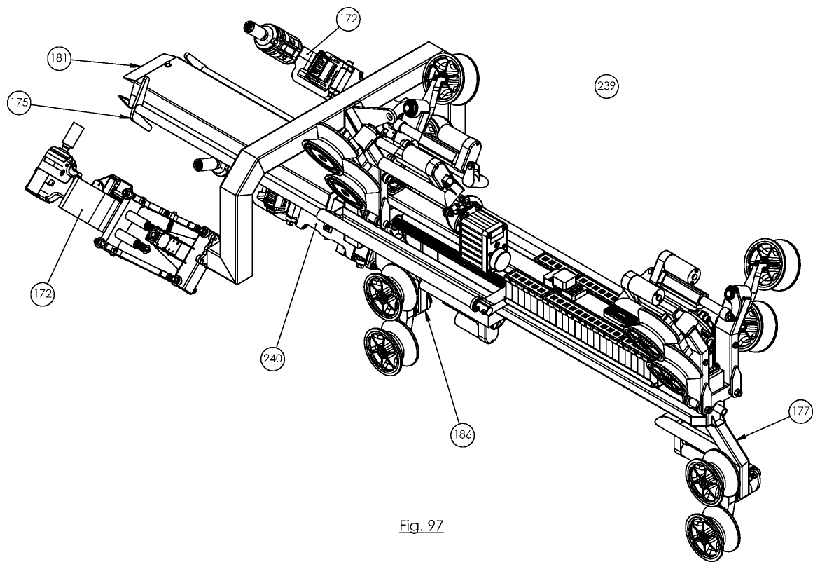

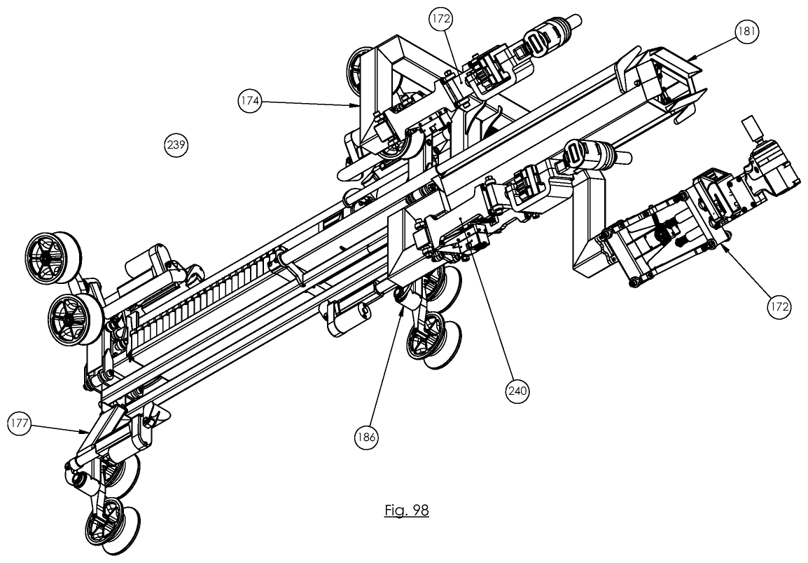

FIG. 97 shows an overhead perspective, and FIG. 98 shows an underside perspective view of how robot 171 can be configured to install a plurality of triple line spacers 219 in the manner depicted in FIG. 15. This version of robot 171 will be referred to as triple spacer robot 239. To modify robot 171 into triple spacer robot 239, one each of lower left bogey support arms 177 and right bogey support arms 186 are removed and the remaining lower left bogey support arm 177 and right bogey support arm 186 are centered with respect to the triple spacer robot 239 and rigidly fixed into place by being directly connected to frame 174. The external shape of magazine assembly 181 is modified to suit the shape of triangular hole 222, which perforates main body 218 of triple line spacer 219, allowing magazine assembly 181 to accept a plurality of triple line spacers 219. The two existing installation arm assemblies 172 can be rigidly fixed into place in the orientation shown by being directly connected to frame 174 and the arm servo actuators 238 are removed. A third underside installation arm assembly 240 can be rigidly fixed into place by being directly connected to frame 174 and aligned as shown.

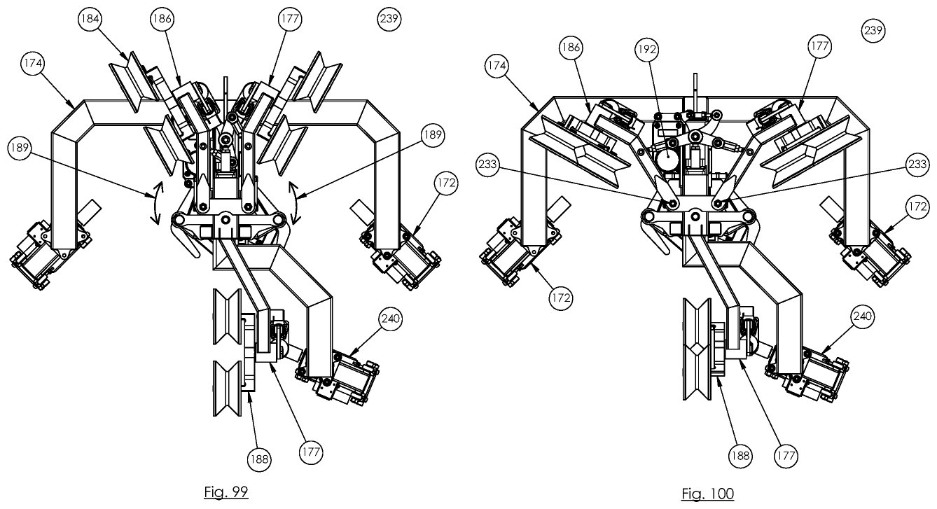

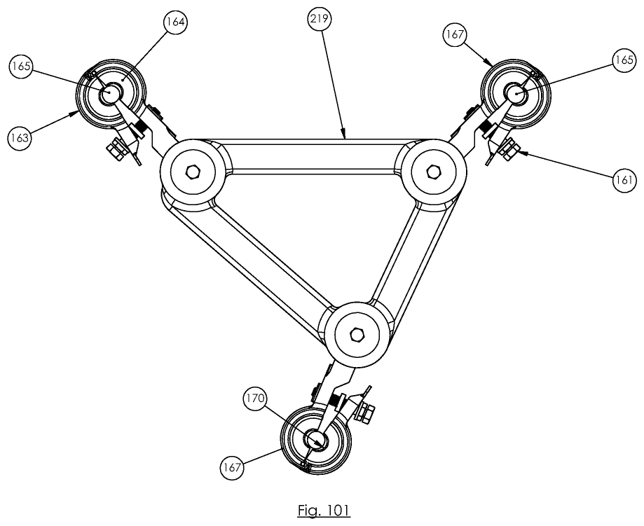

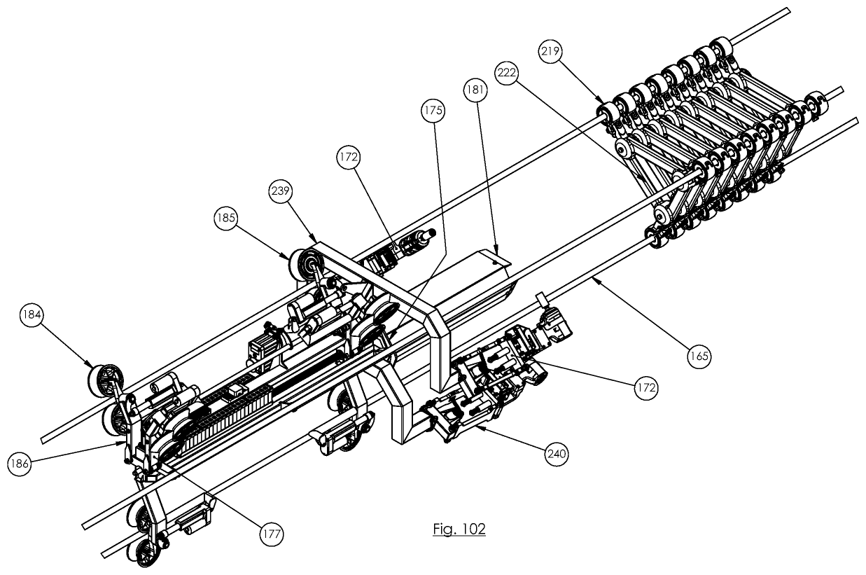

FIG. 99 shows a front view depicting the mounting configuration of triple spacer robot 239, and FIG. 100 shows a front view depicting the installation configuration of left bogey support arms 177 and right bogey support arms 186. This mounting configuration can permit the passage of the triple spacer robot 239 between a set of three wires 165 in order to mount the robot 239 onto the wires 165 using the wheel bogey assemblies 176 and 188. In some embodiments, upper left hand bogey support arms 177 and right hand bogey support arms 186 can be connected to frame 174 via hinges 233 that allow them to pivot about frame 174 in a manner indicated by arrows 189. The rotary output shaft of arm servo motor 192 can be connected to left hand bogey support arms 177 and right hand bogey support arms 186 through a system of shafts, levers and linkages in such a manner as to allow rotation of the output shaft of arm servo motor 192 as commanded by the human operator via the transmitter 31 to cause rotation of left hand bogey support arms 177 and right hand bogey support arms 186 about their respective hinges 233 in the manner indicated by arrows 189. This can allow the human operator to command robot 239 to change configuration from that depicted in FIG. 99 to that depicted in FIG. 100, and back again as required during the process of installing robot 239 onto the plurality of wires 165 to install and to uninstall robot 239 from the plurality of wires 165.

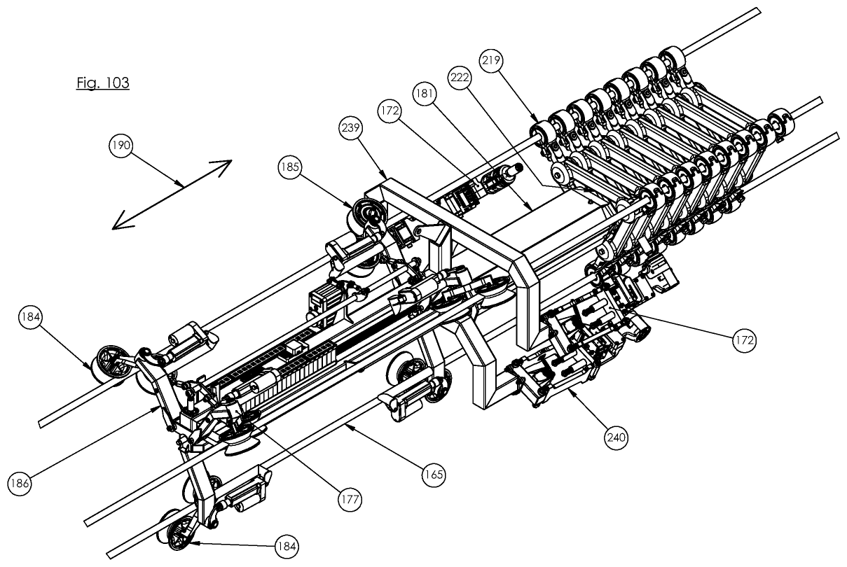

FIG. 101 shows a depiction of triple line spacer 219 after loose installation onto three wires 165. In this configuration, it can be seen that wires 165 are captivated by the wire retaining blocks 164 but triple line spacer 219 is still free to move axially along the three wires 165.

FIG. 102 depicts the process of mounting triple spacer robot 239 onto the plurality of wires 165. Prior to installing the triple spacer robot 239, the human operator must install the number of triple line spacers 219 desired to be installed on the plurality of wires 165 at a position substantially clear of the location of which the triple spacer robot 239 will be mounted upon the wires 165. The triple line spacers 219 must be installed in the manner depicted in FIG. 101, in which clamping bolts 161 are only partially threaded into threaded holes 217 of clamping arms 167, securing the plurality of triple line spacers 219 to the plurality of wires 165 but allowing them to freely slide axially along the plurality of wires 165.

Before lifting triple spacer robot 239 into position, spring loaded pusher assembly 175 must be cocked and locked into position as shown in FIGS. 74, 75, 76 and 77 and described in detail above herein. Note that the operation of spring loaded pusher assembly 175 for triple spacer robot 239 is identical of that for robot 171.

Once the plurality of triple line spacers 219 have been partially installed on wires 165 in the manner depicted in FIG. 102, triple spacer robot 239 can be lowered between the wires 165 with left bogey support arms 177 and right bogey support arms 186 positioned as shown in FIG. 102 such that they are substantially clear of wires 165. Once triple spacer robot 239 is positioned within wires 165, left bogey support arms 177 and right bogey support arms 186 can be commanded to spread apart along arrow 189 to align the wires 165 substantially within the driven wheel bogey assemblies 176 and idler wheel bogey assemblies 188. When wires 165 are substantially aligned within the wheel bogey assemblies 176 and 188, wheel bogey assemblies 176 and 188 can be commanded to rotate to confine wires 165 between the grooves of driven wheels 185 and idler wheels 184.

FIG. 103 depicts triple spacer robot 239 once left bogey support arms 177 and right bogey support arms 186 have been fully spread and driven wheel bogey assemblies 176 and idler wheel bogey assemblies 188 have been rotated to substantially captivate wires 165. When this process is complete, triple spacer robot 239 is supported by, and free to drive along, wires 165 in the direction shown by arrow 190. The human operator can then command triple spacer robot 239 to drive towards the plurality of triple line spacers 219 in the direction of arrow 190. This can cause magazine assembly 181 of triple spacer robot 239 to slide into triangular holes 222 that perforate the main body 218 of triple line spacers 219. This is possible because the external shape of magazine assembly 181 of triple spacer robot 239 closely matches the internal shape of triangular holes 222 of triple line spacers 219. When magazine assembly 181 is fully inserted into main bodies 218 of the plurality of triple line spacers 219 (referring to FIGS. 112, 113 and 114), retention pin assembly 210 can be commanded to extend retention pins 202 to captivate triple line spacers 219 onto magazine assembly 181. When retention pins 202 are in place (similar to as shown in FIGS. 76, 77 and 78), locking pin 223 can be manually removed from spigot hole 228 in spigot 225, releasing pusher assembly 175 and allowing pusher assembly 175 to apply force to triple line spacers 219 into magazine assembly 181 due to the tension force in stretched tension spring 224, wherein triple line spacers 219 are fully seated against the retention pins 202.

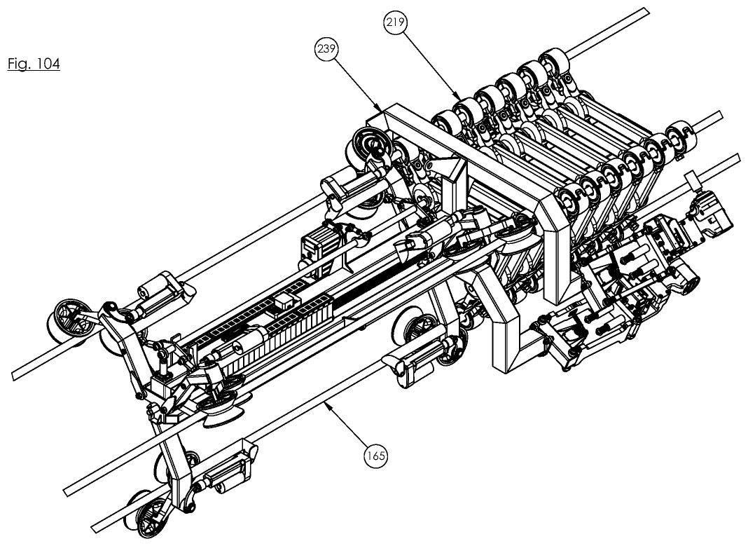

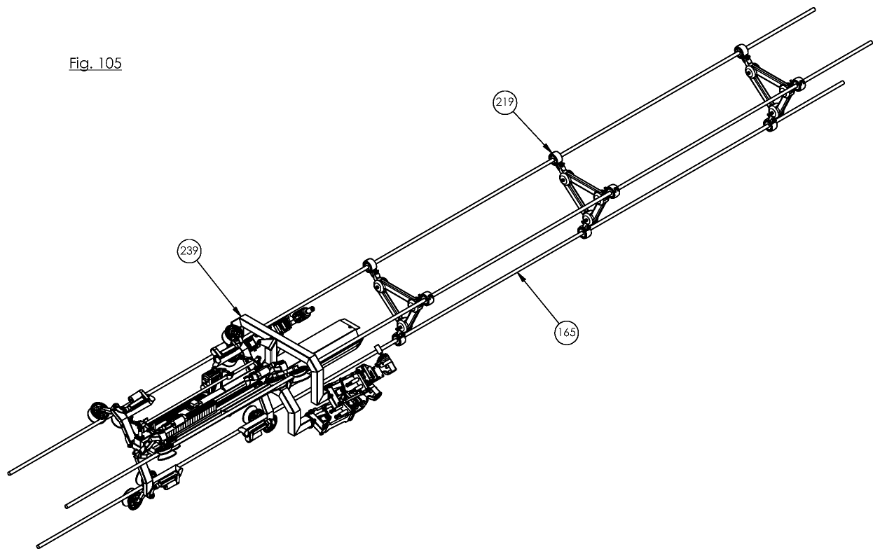

FIG. 104 shows triple spacer robot 239 fully loaded with triple line spacers 219 and prepared to begin installation. The human operator can now command triple spacer robot 239 to drive along the line and command installations of triple line spacers 219 at a plurality of predetermined locations along wires 165 as shown in FIG. 105.

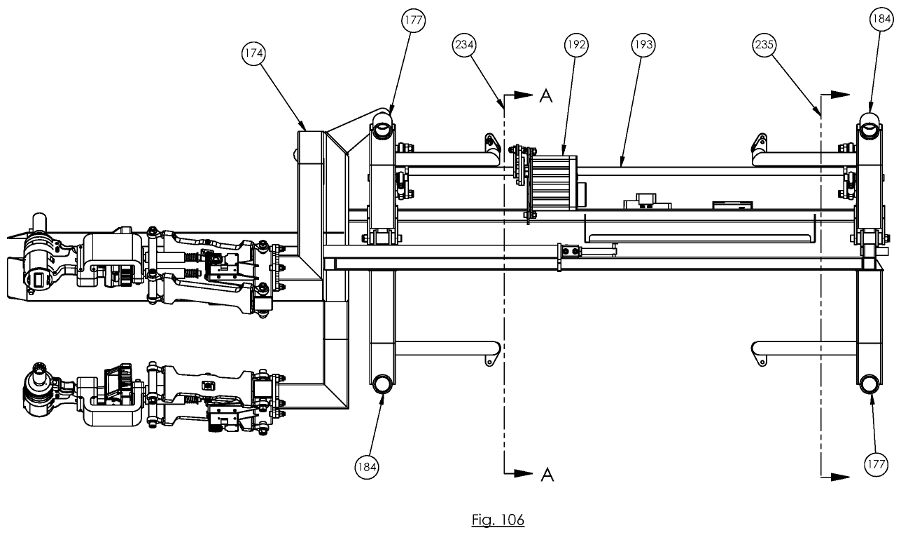

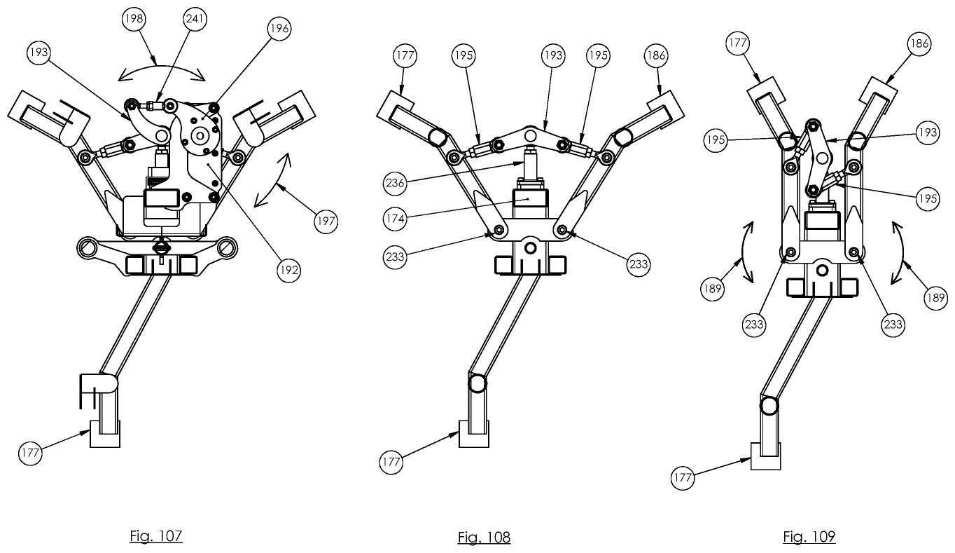

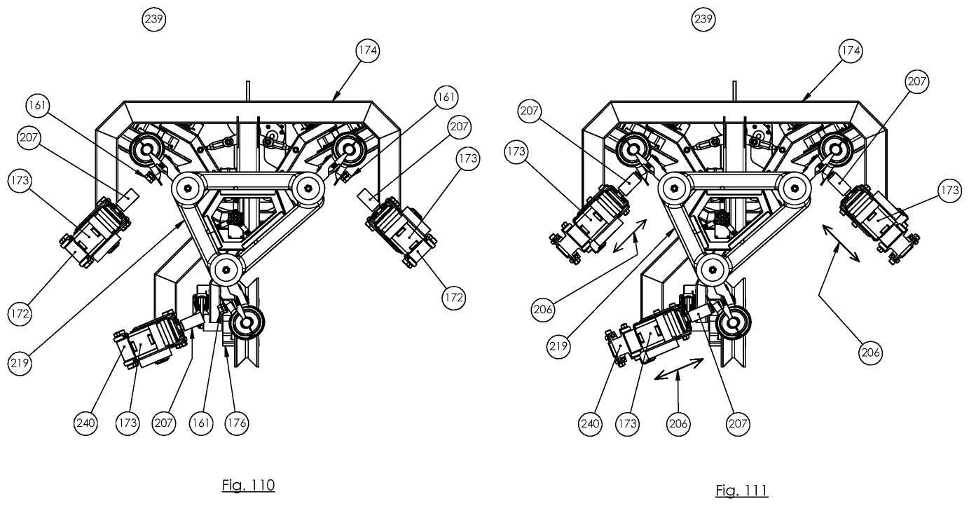

FIG. 106 depicts a side view of triple spacer robot 239. FIG. 107 depicts a section view of FIG. 106 through line 234, and shows the mechanism that can move left bogey support arms 177 and right bogey support arms 186 in unison. FIG. 108 depicts a section view of FIG. 106 through line 235, and shows left bogey support arms 177 and right bogey support arms 186 in the extended configuration. FIG. 109 depicts a section view of FIG. 106 through line 235 and shows left bogey support arms 177 and right bogey support arms 186 in the retracted configuration. The mechanism shown in FIG. 108 and FIG. 109 is duplicated situated at the opposing end of triple spacer robot 239 to provide positional control over the second group of one left bogey support arms 177 and one right bogey support arms 186, as shown in FIG. 104 and FIG. 105.

Referring to FIG. 107, short arm linkage 241 can transmit commanded rotational motion about arrow 197 from arm servo motor 192 through servo horn 196 to top pivot arm 193. The outer extremities of top pivot arm 193 can be rotatably connected to robot frame 174 using bearing blocks 236. In some embodiments, top pivot arm 193 can be connected to left bogey support arms 177 and right bogey support arms 186 with linkages 195 that can translate the rotation about arrow 198 of top pivot arm 193 into rotation of left bogey support arms 177 and right bogey support arms 186 about hinges 233, as depicted by arrows 189 in FIG. 109. This can allow left bogey support arms 177 and right bogey support arms 186 to be positioned as desired by computer 28 for clearance between wires 165 and installation.

To see the function and operation of driven wheel bogey assemblies 176 and idler wheel bogey assemblies 188 with respect to triple spacer robot 239, see FIGS. 87, 88 and 89 and the description above herein.

FIG. 110 depicts a rear view of robot 239 in the pre installation configuration. In some embodiments, left and right installation arm assemblies 172 and underside installation arm assembly 240 can be rigidly fixed to frame 174. In some embodiments, installation arm assemblies 172 and underside installation arm assembly 240 can be aligned such that the plurality of impact wrenches 173, which form part of the installation arm assemblies 172, and underside installation arm assembly 240 are aligned substantially concentrically with the three partially inserted clamping bolts 161 on the triple line spacer 219. In some embodiments, impact wrench 173 can be any suitably configured handheld rotary driver that has the ability to develop sufficient torque, for example, the M18 FUEL™ ¼″ Hex Impact Driver manufactured by Milwaukee Electric Tool Corporation of Brookfield, Wisconsin. The construction and operation of installation arm assemblies 172 and underside installation arm assembly 240 is functionally identical to the bolt tightening assembly 26 of robot 19, the details of which are shown in FIGS. 65, 66, 67 and 68 and described above herein. Note that the orientation and placement of impact wrench 173 differs between bolt tightening assembly 26 of robot 19 and installation arm assembly 172 and underside installation arm assembly 240 of triple spacer robot 239, but this does not significantly change the nature of the operation of the device.

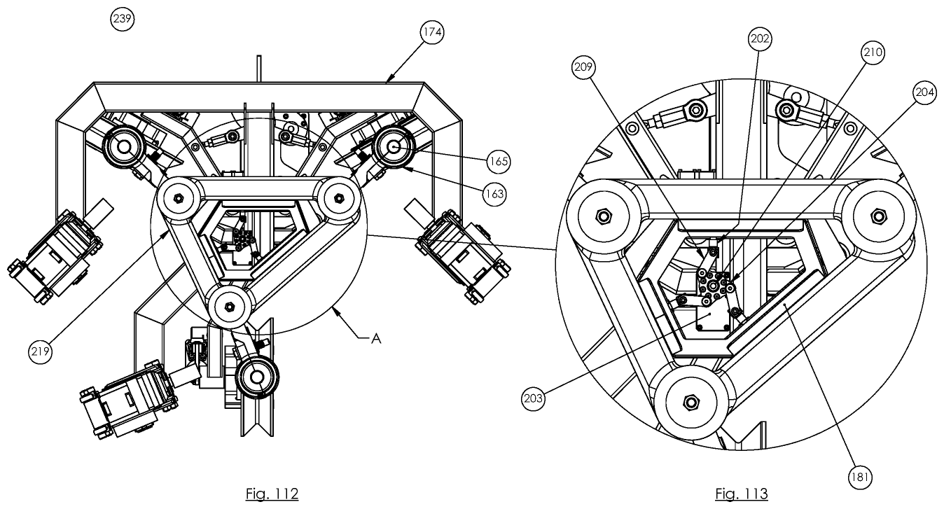

Referring FIG. 111, to tighten clamping bolts 161 of triple line spacer 219, installation arm assemblies 172 and underside installation arm assembly 240 can be commanded to move attached impact wrench 173 toward clamping bolts 161 in the direction depicted in FIG. 91 along arrows 206. The mechanism that achieves this motion is similar to that shown in FIGS. 65, 66, 67 and 68 and described in detail above herein. Once the motion of installation arm assemblies 172 is complete, impact wrench sockets 207 can be substantially seated upon clamping bolts 161 to allow the transmission of torque from impact wrench 173 to clamping bolts 161 rotating them and compressing hinged clamp mechanism 163 as impact wrenches 173 are commanded to tighten clamping bolts 161 by computer 28. As the clamping bolt is rotated, the installation arms can move impact wrenches 173 along arrows 206 to maintain sufficient engagement of impact wrench sockets 207 with the heads of clamping bolts 161 while tightening, as seen in FIG. 111. Clamping bolt 161 can force hinged clamp mechanisms 163 to rotate about the hinged connection towards clamping arms 167 to which hinged clamp mechanisms 163 can be rotatably attached. This can also compress wire retaining blocks 164 around wires 165 until specified torque is achieved to break away the specially designed head of clamping bolt 161 head. This process is similar to that shown in FIG. 57 and FIG. 61 and described in detail above herein. After this has occurred on all three extremities of triple line spacer 219, installation arm assemblies 172 and underside installation arm assembly 240 can be commanded to move attached impact wrench 173 away from the recently tightened clamping bolts 161 in the direction depicted in FIG. 111 along arrows 206.

FIG. 112 depicts a complete installation of a triple line spacer 219 with all hinged clamp mechanisms 163 installed on wires 165. Once this has occurred, the newly installed triple line spacer 219 can be released from magazine assembly 181 by retaining pin mechanism 210, and triple spacer robot 239 can be commanded to move a short distance along wires 165 away from the newly installed triple line spacer 219. The distance moved by the triple spacer robot 239 is enough to allow the newly installed triple line spacer 219 to clear magazine assembly 181 but not too much as to allow the next triple line spacer 219 stored in magazine assembly 181 to clear the magazine assembly 181. Once this motion is complete, retaining pin mechanism 210 can engage to trap the next triple line spacer 219 stored in magazine assembly 181 to prevent it from falling out of magazine assembly 181. Triple spacer robot 239 can then be commanded to move along wires 165 to the next install location where the actions described above herein can be repeated to install the next triple line spacer 219 stored in magazine assembly 181. These actions can be repeated until all desired triple line spacers 219 have been installed on wires 165 as depicted in FIG. 105.

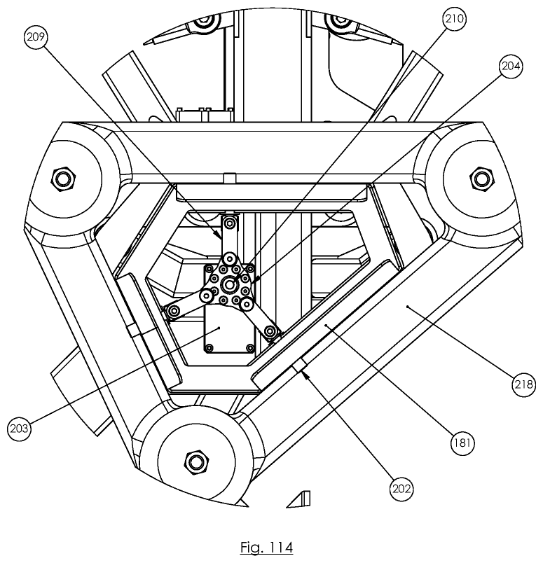

FIG. 113 shows a detailed view of FIG. 112 showing retaining pin mechanism 210 in the retracted configuration, as used when releasing an installed triple line spacer 219 from magazine assembly 181. FIG. 114 shows the same view as FIG. 113 but with retaining pin mechanism 210 in the extended configuration, as used when preventing uninstalled triple line spacers 219 stored in magazine assembly 181 from being mechanism 210 is to contain one or more triple line spacer 219 within magazine assembly 181, as well as controlling the release of a triple line spacer 219 from magazine assembly 181 after it has been installed on wires 165. A plurality of retention pins 202 can be connected to central retention pin servo plate 204 by retention pin linkages 209. In some embodiments, retention pin servo plate 204 can be rotationally locked to the output shaft of retention pin servo 203 such that rotation of the output shaft of retention pin servo 203 can directly rotate retention pin servo plate 204. The linkage mechanism is designed such that commanded rotation of retention pin servo plate 204 translates the plurality of retention pins 202 from their fully extended positions, as shown in FIG. 114, to their retracted positions, as shown in FIG. 113, to allow for controlled release of installed triple line spacer 219 once the installation is complete. This can occur because in the extended configuration, main body 218 of rearmost triple line spacer 219 within magazine assembly 181 can physically contact the extended ends of retention pins 202, preventing triple line spacer 219 from moving past the end of magazine assembly 181. When retention pins 202 are retracted by commanded rotation of retention pin servo plate 204, this contact no longer occurs and the installed triple line spacer 219 is able to physically move past the end of magazine assembly 181.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for installing spacers on at least two wires configured as a span of the wires, each of the spacers comprising at least one clamping bolt for clamping the spacers to the span of the wires, the apparatus comprising:
a) a rolling chassis configured to move along the span of the wires;
b) a magazine assembly operatively disposed on the rolling chassis, the magazine assembly configured to hold at least one of the spacers, the magazine assembly further configured to position one of the spacers on the span of the wires; and
c) a bolt tightening assembly disposed on the rolling chassis, the bolt tightening assembly configured to fasten the spacers onto the span of the wires.

2. The apparatus as set forth in claim 1, wherein the rolling chassis comprises a plurality of wheel truck assemblies that are configured to contact the span of wires and to move the rolling chassis along the span of the wires.

3. The apparatus as set forth in claim 2, wherein the plurality of wheel truck assemblies comprises one or more wheels further comprising an electric motor disposed therein powered by a battery disposed on the apparatus.

4. The apparatus as set forth in claim 2, wherein the rolling chassis comprises at least two front wheels configured to stabilize the rolling chassis on the span of the wires.

5. The apparatus as set forth in claim 1, further comprising a computer, a radio modem operatively coupled to the computer, and at least one antenna operatively coupled to the radio modem disposed thereon, the radio modem configured to receive wireless commands from a ground station via the at least one antenna and to relay the wireless commands to the computer, wherein the computer is configured to control operation of one or more of the rolling chassis, the magazine assembly and the bolt tightening assembly in response to the wireless commands.

6. The apparatus as set forth in claim 1, wherein the bolt tightening assembly comprises:
a) a support arm operatively coupled to the rolling chassis;
b) an impact wrench comprising a socket configured for tightening the at least one clamping bolt; and
c) a positioning mechanism operatively coupling the impact wrench to the support arm, the positioning mechanism configured to lower and raise the impact wrench to and from the spacers thereby enabling the socket to engage the at least one clamping bolt.

7. The apparatus as set forth in claim 6, wherein the positioning mechanism further comprises a side movement mechanism operatively coupling the impact wrench to the positioning mechanism thereby enabling side to side movement of the impact wrench within the positioning mechanism as the impact wrench and the socket tightens the at least one clamping bolt.

8. The apparatus as set forth in claim 7, wherein the side movement mechanism comprises slide rods slidably coupled to slide tubes.

9. The apparatus as set forth in claim 1, wherein the apparatus is configured for installing a plurality of the spacers on at least three wires configured as the span of the wires.

10. The apparatus as set forth in claim 9, wherein the magazine assembly further comprises a retention pin assembly configured to engage and retain at least one of the spacers whereby the at least one of the spacers moves along the span of the wires as the rolling chassis moves along the span of the wires.

11. A method for installing spacers on at least two wires configured as a span of the wires, each of the spacers comprising at least one clamping bolt for clamping the spacers to the span of the wires, the method comprising:
a) placing an apparatus on the span of the wires, the apparatus comprising:
i) a rolling chassis configured to move along the span of the wires,
ii) a magazine assembly operatively disposed on the rolling chassis, the magazine assembly configured to hold at least one of the spacers, the magazine assembly loaded with at least one of the spacers, the magazine assembly further configured to position one of the spacers on the span of the wires, and
iii) a bolt tightening assembly disposed on the rolling chassis, the bolt tightening assembly configured to fasten the spacers onto the span of the wires;
b) moving the apparatus along the span of the wires to a position where one of the spacers is to be installed thereon; and
c) clamping the spacer to the span of the wires with the bolt tightening assembly.

12. The method as set forth in claim 11, further comprising moving the rolling chassis along the span of the wires using a plurality of wheel truck assemblies that are configured to contact the span of wires and to move the rolling chassis along the span of the wires.

13. The method as set forth in claim 12, wherein the plurality of wheel truck assemblies comprises one or more wheels further comprising an electric motor disposed therein powered by a battery disposed on the apparatus.

14. The method as set forth in claim 12, wherein the rolling chassis comprises at least two front wheels configured to stabilize the rolling chassis on the span of the wires.

15. The method as set forth in claim 11, wherein the apparatus further comprises a computer, a radio modem operatively coupled to the computer, and at least one antenna operatively coupled to the radio modem disposed thereon, the radio modem configured to receive wireless commands from a ground station via the at least one antenna and to relay the wireless commands to the computer, wherein the computer is configured to control operation of one or more of the rolling chassis, the magazine assembly and the bolt tightening assembly in response to the wireless commands.

16. The method as set forth in claim 11, wherein the bolt tightening assembly comprises:
a) a support arm operatively coupled to the rolling chassis;
b) an impact wrench comprising a socket configured for tightening the at least one clamping bolt; and
c) a positioning mechanism operatively coupling the impact wrench to the support arm, the positioning mechanism configured to lower and raise the impact wrench to and from the spacers thereby enabling the socket to engage the at least one clamping bolt.

17. The method as set forth in claim 16, wherein the positioning mechanism further comprises a side movement mechanism operatively coupling the impact wrench to the positioning mechanism thereby enabling side to side movement of the impact wrench within the positioning mechanism as the impact wrench and the socket tightens the at least one clamping bolt.

18. The method as set forth in claim 17, wherein the side movement mechanism comprises slide rods slidably coupled to slide tubes.

19. The method as set forth in claim 11, wherein the apparatus is configured for installing a plurality of the spacers on at least three wires configured as the span of the wires.

20. The method as set forth in claim 19, wherein the magazine assembly further comprises a retention pin assembly configured to engage and retain at least one of the spacers whereby the at least one of the spacers moves along the span of the wires as the rolling chassis moves along the span of the wires.
